(19) United States
(12) Patent Application Publication
(10) Pub. No.: US 2019/0387580 A1
(43) Pub. Date: Dec. 19, 2019

(54) COMMON SEARCH SPACE DESIGN IN ENHANCED PHYSICAL DOWNLINK CONTROL CHANNEL

(71) Applicant: Intel IP Corporation, Santa Clara, CA (US)

(72) Inventors: Wenting Chang, Beijing (CN); Huaning Niu, San Jose, CA (US); Salvatore Talarico, Sunnyvale, CA (US); Qiaoyang Ye, Sunnyvale, CA (US); Yuan Zhu, Beijing (CN)

(73) Assignee: Intel IP Corporation, Santa Clara, CA (US)

(21) Appl. No.: 16/490,263

(22) PCT Filed: Apr. 2, 2018
(86) PCT No.: PCT/US18/25731

§ 371 Date: Aug. 30, 2019

Related U.S. Application Data
(60) Provisional application No. 62/562,030, filed on Sep. 22, 2017.

(30) Foreign Application Priority Data
Mar. 31, 2017 (CN) PCT/CN2017/078997
Sep. 13, 2017 (CN) PCT/CN2017/101541

(51) Int. Cl. H04W 88/06; H04W 16/26; H04W 24/08; H04W 72/04; H04W 74/08; H04W 68/00; H04W 76/11; H04L 5/10; H04L 5/00; H04L 1/00

(52) U.S. Cl. CPC H04W 88/06; H04W 16/26; H04W 24/08; H04W 72/042; H04L 1/0038; H04W 68/005; H04W 76/11; H04L 5/10; H04L 5/0051; H04W 74/0833

(57) ABSTRACT

Described is an apparatus of an Evolved Node-B (eNB) operable to communicate with a User Equipment (UE) on a wireless network. The apparatus may comprise a first circuitry, a second circuitry, and a third circuitry. The first circuitry may be operable to process one or more configuring transmissions from the eNB carrying one or more parameters for Common Search Space (CSS) for Wideband Coverage Enhancement (WCE) mode. The second circuitry may be operable to establish a CSS encompassing one or more enhanced Physical Downlink Control Channel (ePDCCH) candidate transmissions based upon the one or more parameters for CSS for WCE mode. The third circuitry may be operable to monitor the one or more ePDCCH candidate transmissions for Downlink Control Information (DCI) in accordance with the one or more parameters for CSS for WCE mode.

### CLAIM OF PRIORITY

The present application claims priority under 35 U.S.C. § 365(c) to Patent Cooperation Treaty International Patent Application Number PCT/CN2017/078997 filed Mar. 31, 2017 and to Patent Cooperation Treaty International Patent Application Number PCT/CN2017/101541 filed Sep. 13, 2017 and entitled “COMMON SEARCH SPACE DESIGN FOR WIDE COVERAGE ENHANCEMENT USER EQUIPMENT,” and claims priority under 35 U.S.C. § 119(e) to U.S. Provisional Patent Application Ser. No. 62/562,030 filed Sep. 22, 2017 and entitled “COMMON SEARCH SPACE DESIGN FOR WIDE COVERAGE ENHANCEMENT USER EQUIPMENT,” which are herein incorporated by reference in their entirety.

### BACKGROUND

A variety of wireless cellular communication systems have been implemented, including a 3rd Generation Partnership Project (3GPP) Universal Mobile Telecommunications Systems (UMTS) system, a 3GPP Long-Term Evolution (LTE) system, and a 3GPP LTE-Advanced (LTE-A) system. Next-generation wireless cellular communication systems based upon LTE and LTE-A systems are being developed, such as a Fifth Generation (5G) wireless system/5G mobile networks system. Next-generation wireless cellular communication systems may [also] provide support for higher bandwidths in part by using unlicensed spectrum. In addition, next-generation wireless cellular communication systems may provide support for massive numbers of user devices like Narrowband Internet-of-Things (NB-IoT) devices, Cellular Internet-of-Things (CIoT) devices, or Machine-Type Communication (MTC) devices.

### BRIEF DESCRIPTION OF THE DRAWINGS

The embodiments of the disclosure will be understood more fully from the detailed description given below and from the accompanying drawings of various embodiments of the disclosure. However, while the drawings are to aid in explanation and understanding, they are only an aid, and should not be taken to limit the disclosure to the specific embodiments depicted therein.

FIG. 1 illustrates a scenario of an Evolved Node-B (eNB) in wireless communication with one or more User Equipments (UE), in accordance with some embodiments of the disclosure.

FIGS. 2A-2B illustrate an Information element (IE) for enhanced Physical Downlink Control Channel (ePDCCH) for Common Search Space (CSS) in Wideband Coverage Enhancement (WCE) mode, in accordance with some embodiments of the disclosure.

FIG. 3 illustrates an eNB and a UE, in accordance with some embodiments of the disclosure.

FIG. 4 illustrates hardware processing circuitries for a UE for implementing CSS for ePDCCH, in accordance with some embodiments of the disclosure.

FIG. 5 illustrates methods for a UE for implementing CSS for ePDCCH, in accordance with some embodiments of the disclosure.

FIG. 6 illustrates methods for a UE for implementing CSS for ePDCCH, in accordance with some embodiments of the disclosure.

FIG. 7 illustrates example components of a device, in accordance with some embodiments of the disclosure.

FIG. 8 illustrates example interfaces of baseband circuitry, in accordance with some embodiments of the disclosure.

### DETAILED DESCRIPTION

Various wireless cellular communication systems have been implemented or are being proposed, including 3rd Generation Partnership Project (3GPP) Universal Mobile Telecommunications Systems (UMTS), 3GPP Long-Term Evolution (LTE) systems, 3GPP LTE-Advanced (LTE-A) systems, and 5th Generation (5G) wireless systems/5G mobile networks systems/5G New Radio (NR) systems.

Due to the popularity of mobile devices and smart devices, the widespread adoption of wireless broadband has resulted in significant growth in the volume of mobile data traffic and has radically impacted system requirements, sometimes in divergent ways. For example, while it may be important to lower complexity, elongate battery life, and support highly mobility and service continuity of devices, it may also be important to increase data rates and bandwidths and lower latencies to support modern applications.

To meet the needs of future wireless networks, various physical layer techniques have been introduced (e.g, Multiple Input Multiple Output (MIMO) techniques, enhanced Inter-Cell Interference Coordination (ICIC) designs, coordinated multi-point designs, and so on). An increasing interest has also arisen in operating cellular networks in unlicensed spectrum to ameliorate the scarcity of licensed spectrum in low frequency bands, with the aim to further improve data rates. One enhancement for LTE in 3GPP Release 13 has been to enable operation in unlicensed spectrum via Licensed-Assisted Access (LAA), which may expand a system bandwidth by utilizing a flexible carrier aggregation (CA) framework introduced by the LTE-Advanced system. Enhanced operation of LTE systems in unlicensed spectrum is also expected in future releases, as well as in 5G systems.

Potential LTE operations in unlicensed spectrum may include (but not be limited to) LTE system operation in the unlicensed spectrum via Dual Connectivity (DC) (e.g., DC-based LAA), as well as LTE-based technology operating solely in unlicensed spectrum without relying upon an “anchor” in licensed spectrum (such as in MulteFire™ technology by MulteFire Alliance of Fremont Calif., USA).

Meanwhile, Internet-of-Things (IoT) functionality is envisioned as a significantly important technology component, which has potential to impact our lives by enabling connectivity between large numbers of devices. IoT may have a wide variety of applications in various scenarios, such as smart city applications, smart environment applications, smart agriculture applications, and smart health-system applications.

3GPP has standardized two designs for supporting IoT services: enhanced Machine-Type Communication (eMTC) and NarrowBand IoT (NB-IoT). As eMTC and NB-IoT UEs may be deployed in large numbers, lowering the cost of UEs for these services may be important to enable implementation of IoT. Moreover, low-power consumption may be desirable to extend battery life for such devices. There may also be substantial use-cases of devices deployed deep inside buildings, which may require Coverage Enhancement (CE) in comparison with the defined LTE cell-coverage footprint. In summary, eMTC and NB-IoT techniques may support UEs having low cost, low power consumption, and/or enhanced coverage.

To extend the benefits of LTE IoT designs into unlicensed spectrum, MulteFire™ may specify designs for Unlicensed-IoT (U-IoT) based on eMTC and/or NB-IoT. Unlicensed frequency bands of current interest for NB-IoT and/or eMTC-based U-IoT may be a band below 1 Gigahertz (GHz) band and a band around 2.4 GHz.

In addition to potentially differing from eMTC and/or NB-IoT which may apply to narrowband operation, Wideband Coverage Enhancement (WCE) may also be targeted for operational bandwidths of 10 megahertz (MHz) and 20 MHz. WCE may extend MulteFire™ coverage to meet industry IoT market needs, and may accordingly target operating bands at approximately 3.5 GHz and/or 5 GHz.

Frequency bands of 3.5 GHz and 5 GHz may both have wide spectrum and have global common availability. The 5 GHz band in the US is governed by the Federal Communications Commission (FCC) under Unlicensed National Information Infrastructure (U-NII) rules. The main incumbent system in the 5 GHz band may be Wireless Local Area Networks (WLAN), specifically those based on IEEE 802.11 a/n/ac technologies. Since WLAN systems may be widely deployed both by individuals and operators for carrier-grade access service and data offloading, sufficient care must be taken before deployment. Listen-Before-Talk (LBT) is accordingly considered an advantageous feature of Release-13 LAA systems and MulteFire™ for fair coexistence with incumbent systems. LBT is a procedure whereby radio transmitters first sense a medium, and transmit on the medium if it is sensed to be idle.

On the other hand, for unlicensed operation in a band below 1 GHz and a band around 2.4 GHz, regulations may be different for different regions (e.g., with respect to such aspects as different maximal channel bandwidth, LBT, duty cycling, frequency hopping, and power limitations). For example, in Europe, it may be required to have either LBT or less that 0.1% duty cycle for Frequency Hopping Spread Spectrum (FHSS) modulation with a channel BW of no less than 100 kilohertz (kHz) within 863-870 MHz, and for Digital Modulation with a channel BW no greater than 100 kHz within 863-870 MHz. Either LBT and/or frequency hopping may be used for coexistence with other unlicensed band transmissions.

Various designs for Discovery Reference Signal (DRS) may pertain to WCE and/or eMTC-based U-IoT systems.

In legacy LTE systems, Common Search Space (CSS) and UE Search Space (UESS) may be defined in the Physical Design Control Channel (PDCCH) in accordance with the following equation:

L{(Yₖ+m′)mod └N_{CCE,k}/L┘}₊ᵢ

For CSS, Yₖ may be set to 0, and may indicate that the CSS starts from the first Control Channel Element (CCE) and spans various CCEs. For UESS, Yₖ may be defined by Yₖ=(A·Yₖ₋₁)mod D, and a starting CCE may be dynamically changed at different subframes, where: Y₋₁=n_{RNTI}≠0; A=39827; D=65537; and k=└nₛ/2┘. In various embodiments, there may be overlap between CSS and UESS.

CSS may carry Downlink Control Information (DCI) that is common for all UEs. Such DCIs may carry various Radio Network Temporary Identifiers (RNTIs), such as System Information RNTI (SI-RNTI), Paging Information RNTI (PI-RNTI), or Random Access RNTI (RA-RNTI), for example, or Uplink (UL) Transmit Power Control (TPC) commands. A UE may monitor the CSS using various Aggregation Level (AL) (e.g., 4 and/or 8), and a maximum number of CCEs present in CSS may be 16.

In various embodiments, UESS may carry DCIs for UE specific allocations using the UE's assigned Cell RNTI (C-RNTI), Semi-Persistent Scheduling (SPS) C-RNTI, or a temporary C-RNTI. The UE may monitor the UESS using various AL (e.g., 1, 2, 4, and/or 8).

As for m′, for CSS, m′=m, while for UESS, if the monitoring UE is configured with a carrier indicator field, then m′=m+M^{(L)}n_{CI}, where n_{CI} may be a carrier indicator value; else, if the monitoring UE is not configured with carrier indicator field, then m′=m, where m=0, 1, . . . M^{(L)} may be the number of PDCCH candidates to monitor in a given search space.

In comparison, in enhanced Physical Downlink Control Channel (ePDCCH), the UESS may be defined, and enhanced Control Channel Element (eCCE) indices may be computed in accordance with the following equation:

$$L \{ ( {Y}_{p , k} + ⌊ \frac{m \cdot {N}_{ECCE , p , k}}{L \cdot {M}_{p}^{( L )}} ⌋ + b ) mod ⌊ {N}_{ECCE , p , k} / L ⌋ \} + i$$

where N_{ECCEp,k} may be a number of eCCEs in an ePDCCH PRB set p of subframe k. In comparison with legacy PDCCH, b=n_{CI} if a UE is configured with a carrier indicator field for a serving cell on which ePDCCH is monitored; otherwise, b=0. The relationship

$$⌊ \frac{m * {N}_{ECCE , p , k}}{{M}_{p}^{( L )} * L} ⌋$$

may operate such that different candidates may be evenly distributed with N_{ECCE,p,k} eCCEs. Notice that Mₚ^{L}=└αM_{p,full}^{(L)}┘, where α may be determined in accordance with Table 9.1.1.2 of MulteFire™ Technical Specification 36.213, v. 1.0.0, October 2016, and M_{p,full}^{(L)} may be determined in accordance with Table 9.1.4-1a to Table 9.1.4-5b of MulteFire™ Technical Specification 36.213, v. 1.0.0, October 2016. However, current specifications may merely define UESS for ePDCCH, not CSS for ePDCCH. Moreover, since ePDCCH may be be utilized for broadcasting DCI transmission, the search space, format, and ePDCCH parameter configuration for CSS should be designed.

Discussed herein are methods and mechanisms for implementing CSS for ePDCCH. Some embodiments may pertain to establishing a PRB set and/or candidate configuration. Some embodiments may pertain to eCCE index derivation. Some embodiments may pertain to subframe configuration. Some embodiments may pertain to parameter configuration.

Discussed herein are also methods and mechanisms for implementing CSS for ePDCCH. Some embodiments may pertain to CSS ePDCCH configuration. Some embodiments may pertain to candidate search spaces. Some embodiments may pertain to support for 16 Resource Blocks (RBs) for CSS ePDCCH, which may include merely DCI format 1A and/or DCI format 1A plus DCI format 1C. Some embodiments may pertain to Physical Resource Block (PRB) allocation for CSS ePDCCH in a candidate search. Some embodiments may pertain to support for 32 RBs for CSS ePDCCH, which may include merely DCI format 1A and/or DCI format 1A plus DCI format 1C. Some embodiments may pertain to further enhanced eCCE. Some embodiments may pertain to System Information Block (SIB) Period, some embodiments may pertain to Paging period, and some embodiments may pertain to other related details.

Advantages of the methods and mechanisms for implementing CSS for ePDCCH discussed herein lies in the fact that the proposed solution allows to support CSS in ePDCCH for the wide coverage enhancement system, and if adopted by the MulteFire specification or 3GPP LTE eLAA standard, it is likely that most of the vendors will implement it in their products for compliance.

In the following description, numerous details are discussed to provide a more thorough explanation of embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct electrical, mechanical, or magnetic connection between the things that are connected, without any intermediary devices. The term “coupled” means either a direct electrical, mechanical, or magnetic connection between the things that are connected or an indirect connection through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The terms “substantially,” “close,” “approximately,” “near,” and “about” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking, or in any other manner.

It is to be understood that the terms so used are interchangeable under appropriate circumstances such that the embodiments of the invention described herein are, for example, capable of operation in other orientations than those illustrated or otherwise described herein.

The terms “left,” “right,” “front,” “back,” “top,” “bottom,” “over,” “under,” and the like in the description and in the claims, if any, are used for descriptive purposes and not necessarily for describing permanent relative positions.

For purposes of the embodiments, the transistors in various circuits, modules, and logic blocks are Tunneling FETs (TFETs). Some transistors of various embodiments may comprise metal oxide semiconductor (MOS) transistors, which include drain, source, gate, and bulk terminals. The transistors may also include Tri-Gate and FinFET transistors, Gate All Around Cylindrical Transistors, Square Wire, or Rectangular Ribbon Transistors or other devices implementing transistor functionality like carbon nanotubes or spintronic devices. MOSFET symmetrical source and drain terminals i.e., are identical terminals and are interchangeably used here. A TFET device, on the other hand, has asymmetric Source and Drain terminals. Those skilled in the art will appreciate that other transistors, for example, Bi-polar junction transistors-BJT PNP/NPN, BiCMOS, CMOS, etc., may be used for some transistors without departing from the scope of the disclosure.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

In addition, for purposes of the present disclosure, the term “eNB” may refer to a legacy LTE capable Evolved Node-B (eNB), a next-generation or 5G capable eNB, a Narrowband Internet-of-Things (NB-IoT) capable eNB, a Cellular Internet-of-Things (CIoT) capable eNB, a Machine-Type Communication (MTC) capable eNB, an enhanced MTC (eMTC) capable eNB, an Access Point (AP), and/or another base station for a wireless communication system. The term “gNB” may refer to a 5G-capable or NR-capable eNB. For purposes of the present disclosure, the term “UE” may refer to a legacy LTE capable User Equipment (UE), an NB-IoT capable UE, a CIoT capable UE, an MTC capable UE, an eMTC capable UE, a Station (STA), and/or another mobile equipment for a wireless communication system. The term “UE” may also refer to a next-generation or 5G capable UE.

Various embodiments of eNBs and/or UEs discussed below may process one or more transmissions of various types. Some processing of a transmission may comprise demodulating, decoding, detecting, parsing, and/or otherwise handling a transmission that has been received. In some embodiments, an eNB or UE processing a transmission may determine or recognize the transmission's type and/or a condition associated with the transmission. For some embodiments, an eNB or UE processing a transmission may act in accordance with the transmission's type, and/or may act conditionally based upon the transmission's type. An eNB or UE processing a transmission may also recognize one or more values or fields of data carried by the transmission. Processing a transmission may comprise moving the transmission through one or more layers of a protocol stack (which may be implemented in, e.g., hardware and/or software-configured elements), such as by moving a transmission that has been received by an eNB or a UE through one or more layers of a protocol stack.

Various embodiments of eNBs and/or UEs discussed below may also generate one or more transmissions of various types. Some generating of a transmission may comprise modulating, encoding, formatting, assembling, and/or otherwise handling a transmission that is to be transmitted. In some embodiments, an eNB or UE generating a transmission may establish the transmission's type and/or a condition associated with the transmission. For some embodiments, an eNB or UE generating a transmission may act in accordance with the transmission's type, and/or may act conditionally based upon the transmission's type. An eNB or UE generating a transmission may also determine one or more values or fields of data carried by the transmission. Generating a transmission may comprise moving the transmission through one or more layers of a protocol stack (which may be implemented in, e.g., hardware and/or software-configured elements), such as by moving a transmission to be sent by an eNB or a UE through one or more layers of a protocol stack.

In various embodiments, resources may span various Resource Blocks (RBs), PRBs, and/or time periods (e.g., frames, subframes, and/or slots) of a wireless communication system. In some contexts, allocated resources (e.g., channels, Orthogonal Frequency-Division Multiplexing (OFDM) symbols, subcarrier frequencies, resource elements (REs), and/or portions thereof) may be formatted for (and prior to) transmission over a wireless communication link. In other contexts, allocated resources (e.g., channels, OFDM symbols, subcarrier frequencies, REs, and/or portions thereof) may be detected from (and subsequent to) reception over a wireless communication link.

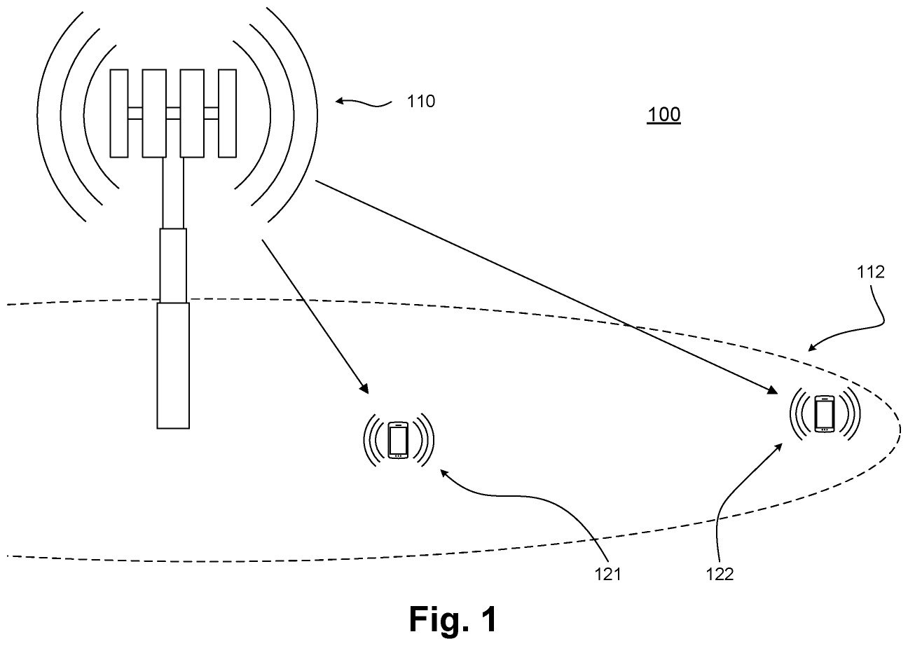

FIG. 1 illustrates a scenario of an Evolved Node-B (eNB) in wireless communication with one or more User Equipments (UE), in accordance with some embodiments of the disclosure. A scenario 100 may comprise an eNB 110 in wireless communication with a first UE 121 and/or a second UE 122 in an area 112. In various embodiments, eNB 110 may be in communication with first UE 121 and/or second UE 122 over unlicensed spectrum. In some embodiments, a CSS for first UE 121 and/or second UE 122 may be defined based on ePDCCH.

Some embodiments may pertain to PRB configuration, PRB set configuration, and/or ePDCCH candidate configuration. In some embodiments, the PRB set for CSS may be configured by an eNB through higher-layer signaling. For some embodiments, the PRBs of CSS may be overlapped with the PRBs of UESS, which may advantageously better utilize available resources. A PRB number for CSS may either be different from a PRB number for UESS, or the same as the PRB number for UESS. For example, an eNB may configure two PRB sets for a UE, where one set might merely be for UESS, and the other set might be overlapped with CSS. For example, for overlapped PRBs, UESS might be formed by PRB {10, 12}, while CSS might be formed by PRB {10, 12, 14, and 15}.

For some embodments, the PRBs of CSS might not be overlapped with the PRBs of UESS, which may advantageously reduce an impact on legacy LTE UEs. Since the AL of CSS may be larger to improve edge UE reception, for CSS, a maximum AL may be used, and may utilize all available eCCEs. For simplicity, configuration of separate CSS PRBs and separate UESS PRBs may be used.

In some embodiments, a total number of PRBs for CSS may be configured by an eNB through higher-layer signaling, and may be enlarged (e.g., to 16, 32, or greater than 32). Accordingly, in various embodiments, the PRB sets of CSS and UESS may be overlapped, or may be orthogonal, according to an eNB's configuration (e.g., via higher-layer signaling). Table 1 below provides examples of ePDCCH candidate (e.g., ePDCCH candidates for CSS).

TABLE 1
Example of ePDCCH candidates

Number of ePDCCH candidates

| N_{RB} | L = 8 | L = 16 | L = 32 | L = 64 |
|---|---|---|---|---|
| 4 | 2 | 1 | 0 | 0 |
| 8 | 3 | 2 | 1 | 0 |
| 16 | 0 | 4 | 2 | 1 |

For some embodiments, a number of ePDCCH sets for CSS may be limited to one to reduce a UE blind detection. In some embodiments, a number of ePDCCH candidates may reuse two for flexibility.

Some embodiments may pertain to eCCE index derivation. In some embodiments, eCCE index derivation may reuse an eCCE indices derivation rule of CCE, such as:

L{(Yₖ+m′)mod └N_{CCE,k}/L┘}₊ᵢ

or it may reuse an eCCE indices derivation rule of eCCE, such as:

$$L \{ ( {Y}_{p , k} + ⌊ \frac{m \cdot {N}_{ECCE , p , k}}{L \cdot {M}_{p}^{( L )}} ⌋ + b ) mod ⌊ {N}_{ECCE , p , k} / L ⌋ \} + i$$

In some embodiments, for a UE, co-existence between CSS PDCCH and CSS ePDCCH may be maintained via a variety of options.

A first option for maintaining co-existence may incorporate CSS in PDCCH and CSS in ePDCCH. A UE may first search CSS in PDCCH. If the UE does not detect CSS in PDCCH, it may continue to search CSS in ePDCCH.

A second option for maintaining co-existence may incorporate CSS in PDCCH or CSS in ePDCCH. An eNB and a UE may synchronize regarding a working mode used (e.g., WCE mode, or normal mode) by using Physical Random Access Channel (PRACH), or higher-layer signaling, or DCI. If the UE works in WCE mode, it may detect CSS in ePDCCH; otherwise, if the UE works in normal mode, it may detect CSS in PDCCH.

In a third option for maintaining co-existence, in case WCE defines higher AL in PDCCH for CSS, and CSS in ePDCCH, a UE may search both CSS in PDCCH and CSS in ePDCCH depending on the DCI carried in CSS in PDCCH or the DCI carried in CSS in ePDCCH.

Some embodiments may pertain to subframe configuration. In some embodiments, a time subframe for ePDCCH CSS might not be configured by a bitmap, but may be configured depending on a System Information (SI) window, a Paging Occasion (PO), and/or a Discovery Reference Signal Transmission Window (DTxW). For example, by default, a UE may detect ePDCCH in CSS at an SI window, a PO, and/or a DTxW.

In some embodiments, a time subframe for ePDCCH in CSS may be configured by an eNB through higher-layer signaling (e.g., a bitmap).

Some embodiments may pertain to parameter configuration. In some embodiments, the parameters related to CSS in ePDCCH configuration may be pre-defined, or may be configured through Master Information Block (MIB) and/or SIB. The parameters may include: a subframe pattern configuration parameter (e.g., “SubframePatternConfig”), which might not need to be configured, and which may use the PO and/or SI window; a start symbol parameter (e.g., “startSymbol”), which might not need to be configured, and which may be set to a default value (e.g., 2); a set configuration Identity (ID) parameter (e.g., “setConfigId”), which might not be needed, if merely one set is enabled for CSS in ePDCCH; a transmission type parameter (e.g., “transmissionType”); a resource block assignment parameter (e.g., “resourceBlockAssignment”), which may in turn include a number-of-PRBs and/or number-of-PRB-pairs parameter (e.g., “numberPRB” and/or “numberPRB-Pairs”) and/or a resource block assignment parameter (e.g., “resourceBlockAssignment”); and/or a Demodulation Reference Signal (DM-RS) parameter (e.g., “dmrs-ScramblingSequenceInt”).

For some embodiments, the PDCCH and/or ePDCCH aggregation level may be extended to advantageously achieve a better link quality for channels in CSS.

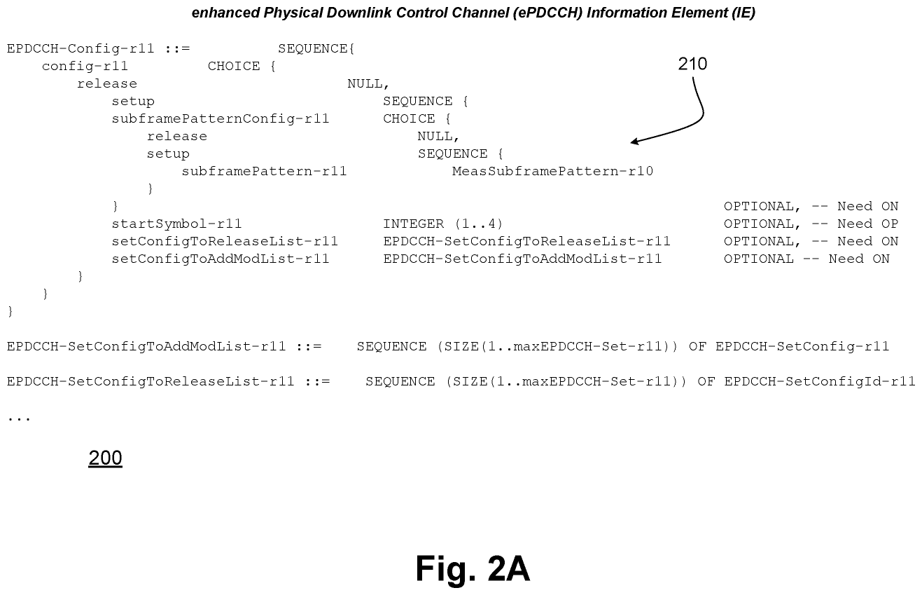

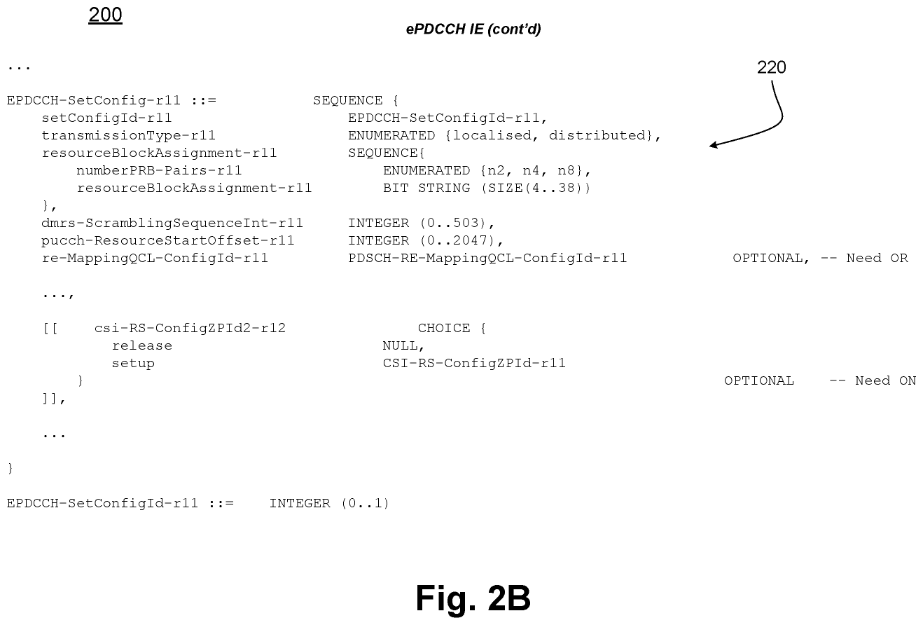

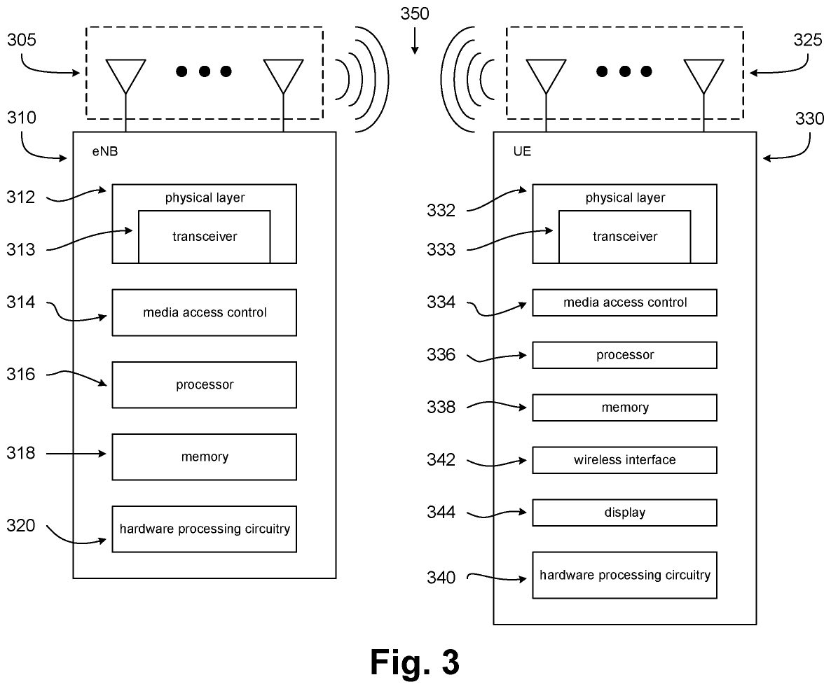

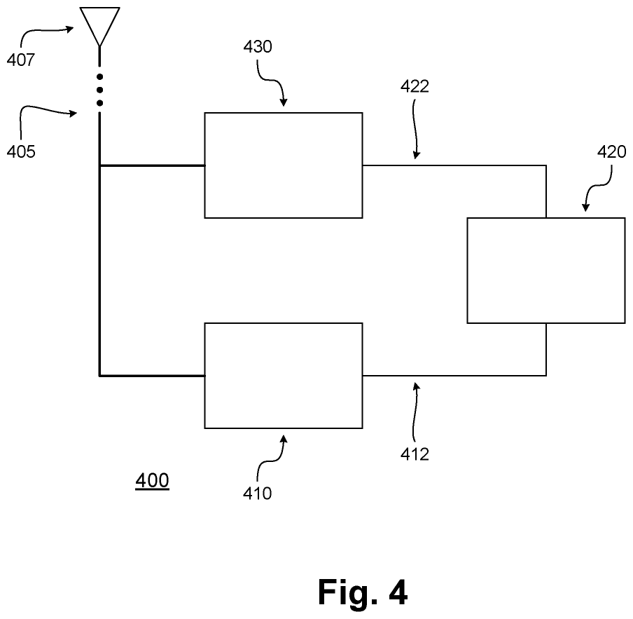

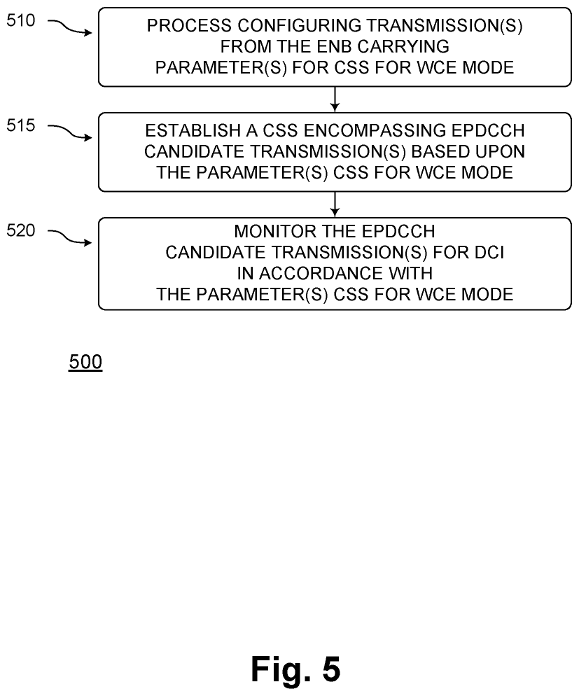

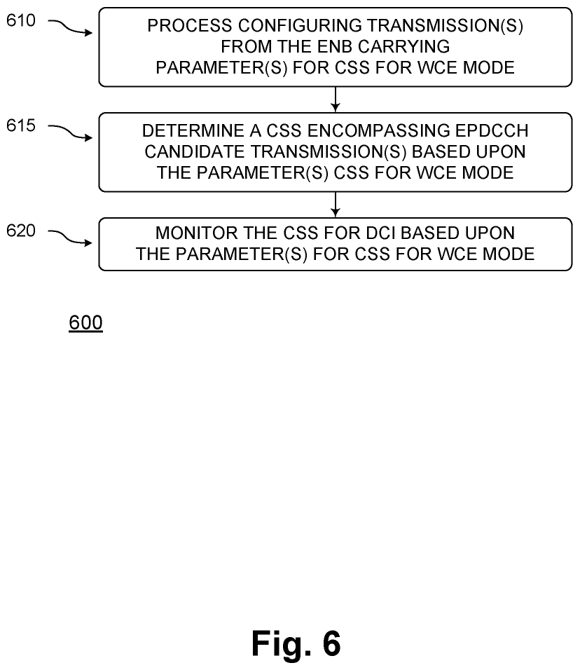

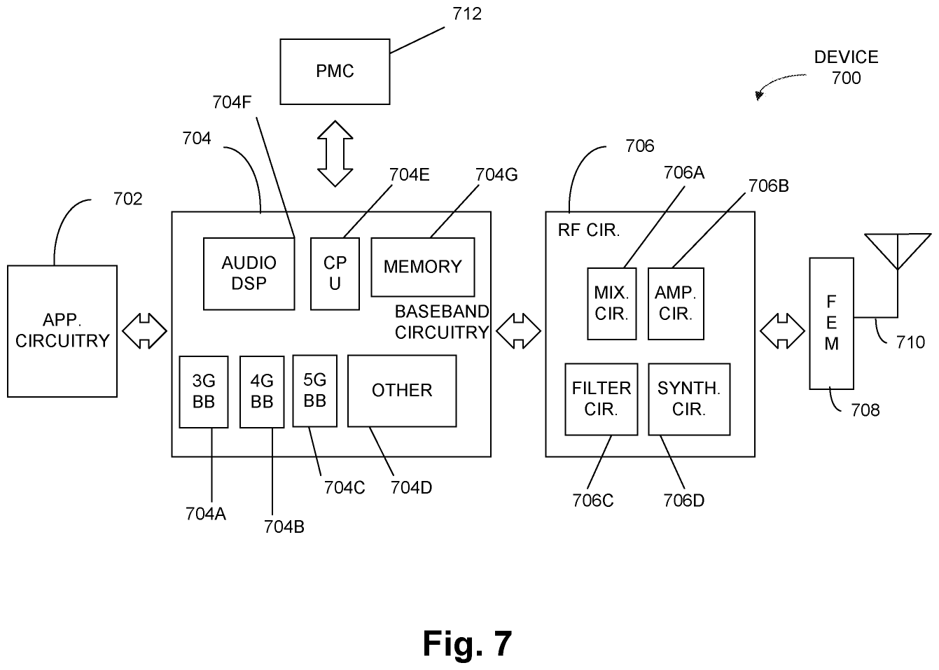

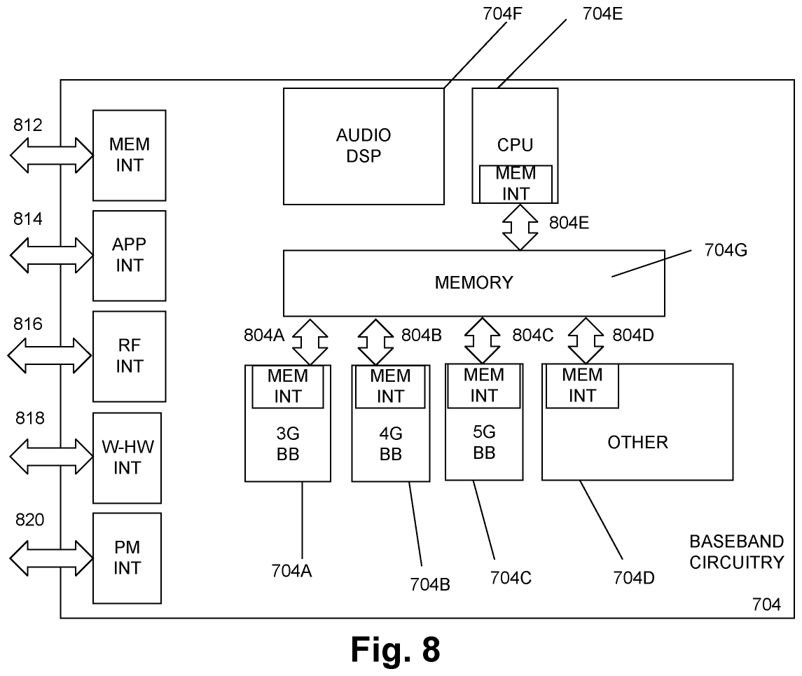

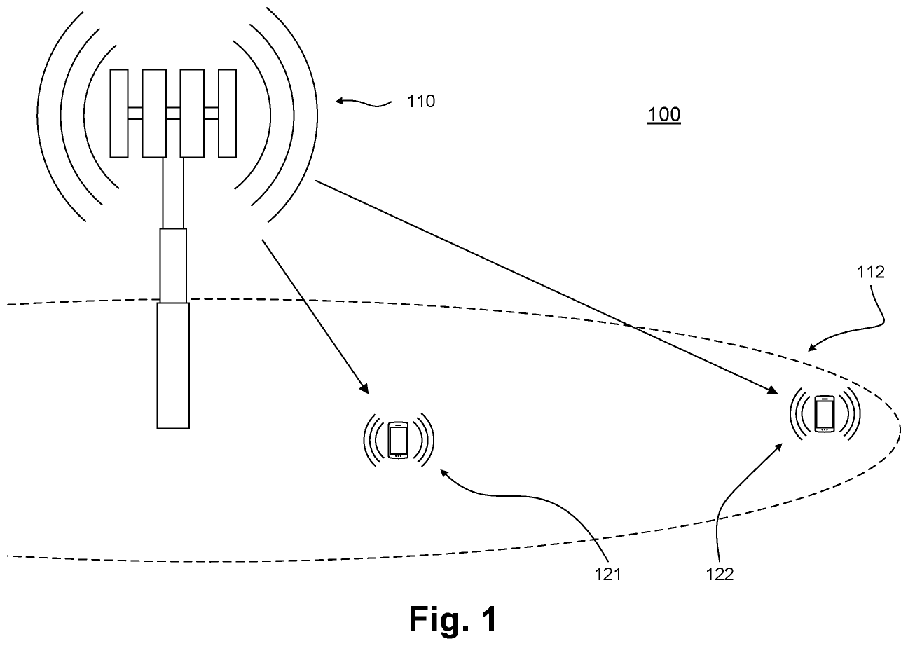

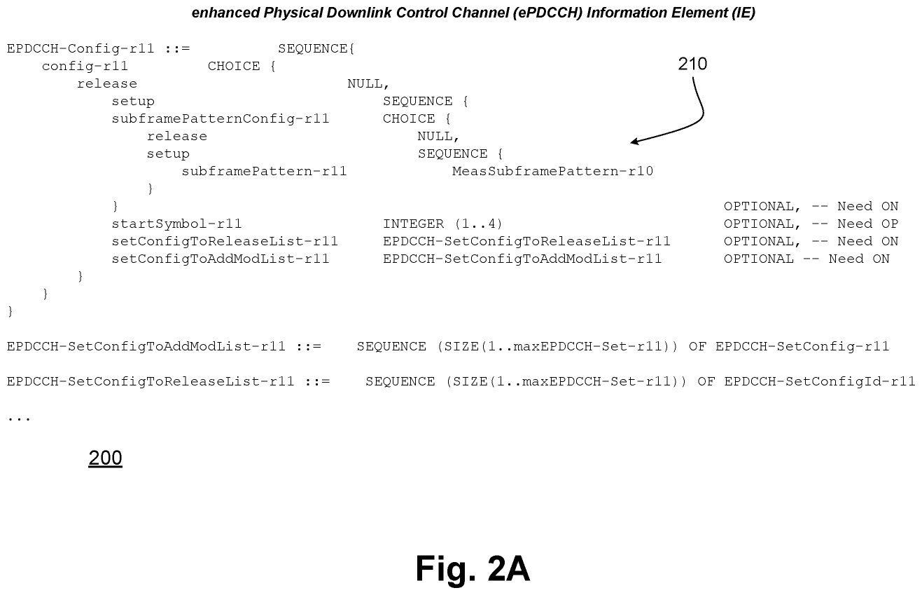

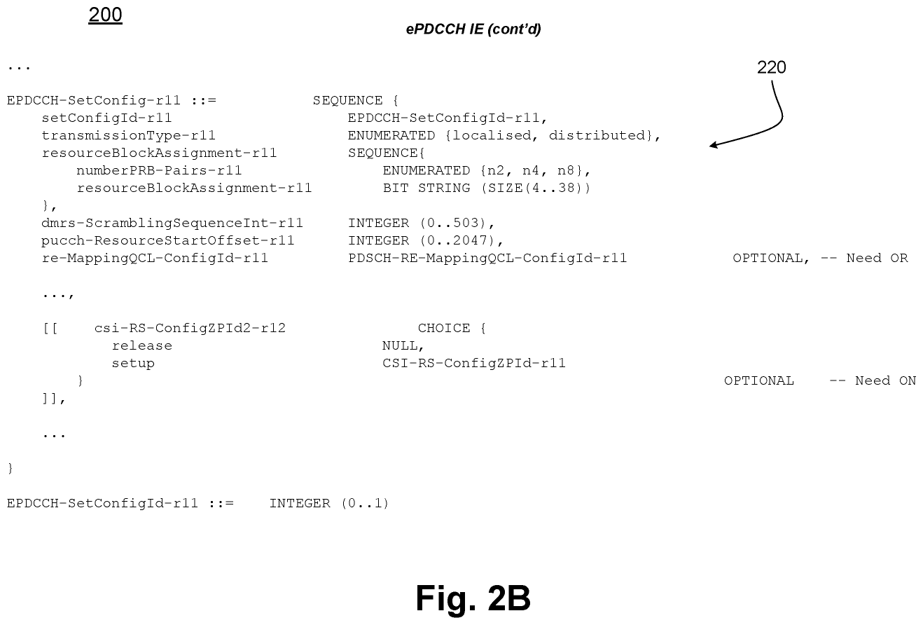

Some embodiments may pertain to CSS ePDCCH configurations. FIGS. 2A-2B illustrate an Information Element (IE) for ePDCCH for CSS in WCE mode, in accordance with some embodiments of the disclosure. A set of IEs 200 may comprise a first part 210 and a second part 220. First part 210 and/or second part 220 may configure various parameters, e.g., for legacy UESS and/or CSS. For example, first part 210 and/or second part 220 may configure a subframe pattern configuration parameter, a start symbol parameter, a set configuration ID parameter, a transmission type parameter, a resource block assignment parameter, a number-of-PRB-pairs parameter, a resource block assignment parameter, and/or a DM-RS parameter.

However, not all of the parameters may be needed for CSS ePDCCH, which may advantageously reduce a signaling overhead. In some embodiments, a subframe pattern configuration parameter, a start symbol parameter, a number-of-PRB-pairs parameter, and/or a resource block assignment parameter might not be contained.

In some embodiments, there may be SI-RNTI, PI-RNTI, RA-RNTI, Transmit Power Control Physical Uplink Control Channel RNTI (TPC-PUCCH-RNTI), and/or Transmit Power Control Physical Uplink Shared Channel RNTI (TPC-PUSCH-RNTI) in the CSS.

In various embodiments, a subframe pattern parameter (e.g., “subframePattern”) may be configured in a variety of ways. In some embodiments, it may be configured by an eNB as a legacy bit field. In some embodiments, it might not be defined, and/or each subframe may be a valid subframe for ePDCCH reception to search CSS. In addition, different DCIs for different broadcast information may be searched in different timing instants. For example, DCI with SI-RNTI may be searched during an SI window; DCI with PI-RNTI may be searched during a PO; and/or DCI with RA-RNTI may be searched during a RAR window occasion.

For various embodiments, a start symbol parameter (e.g., “startSymbol”) may be configured in a variety of ways. In some embodiments, it may be indicated by a Control Format Indicator (CFI) or a Physical Downlink Shared Channel (PDSCH) start parameter (e.g., “pdsch-Start”) as a legacy bit field. For some embodiments, it may be configured by and eNB through a SIB 1 (SIB1) or a MIB. In some embodiments, a start symbol parameter (e.g., “startSymbol”) may be applicable to CSS ePDCCH and an associated PDSCH, and/or to UESS ePDCCH and the associated PDSCH.

In various embodiments, a set-configuration-to-release-list parameter (e.g., “setConfigToReleaseList”) and/or a set-configuration-to-add-mod-list parameter (e.g., “setConfigToAddModList”) may be configured in various ways. In some embodiments, one or both parameters may be pre-defined (e.g., two sets may be configured). For some embodiments, one or both parameters may be configured by an eNB (e.g., through SIB1 or MIB).

In various embodiments, various parameters related to an EPDCCH-Set-Configuration parameter (e.g., “EPDCCH-SetConfig”) may be configured in various ways. A set configuration ID parameter (e.g., “setConfigId”) may be pre-defined, the set configuration being implicitly associated with the configuration sequence; that is, {set 0} may follow {set 1}. A transmission type parameter (e.g., “transmissionType”) may be pre-defined, as in a distributed case, since distributed may support AL=32, or alternatively, it may be configured by eNB through SIB1 or MIB. A number-of-PRB-pairs parameter (e.g., “numberPRB-Pairs”) may e pre-defined (e.g., 8 RBs for each set, or alternatively, it may be configured by eNB through SIB1 or MIB. A resource block assignment parameter (e.g., “resourceBlockAssignment”) may be defined as a legacy resource allocation, or alternatively, it may be pre-defined in units of N contiguous distributed and/or localized Virtual Resource Blocks (VRBs). For example, N may be 4, or 8. With respect to the resource block assignment parameter, one flag may also be configured to indicate (e.g., to a UE) whether a resource configuration is based on continuous PRB or VRB. In some embodiments, the resource block assignment parameter may be hard coded, pre-defined, or otherwise predetermined, or may be blindly detected together with the candidates (e.g., the ePDCCH candidates).

In some embodiments, a DM-RS scrambling sequence parameter (e.g., “dmrs-ScramblingSequenceInt”) may be configured by an eNB through SIB1 and/or MIB, or may be pre-defined or otherwise predetermined (e.g., as a function of a cell ID).

For some embodiments, a Physical Uplink Control Channel (PUCCH) resource start offset parameter (e.g., “PUCCH-ResourceStartOffset”) might not be needed, since Acknowledgement (ACK)/Negative Acknowledgement (NACK) may be disposed to being fed back for data configured by DCI in CSS.

In some embodiments, a mapping Quasi-Co-Location (QCL) configuration ID parameter (e.g., “MappingQCL-ConfigId”) might not be used, or may be optional, since TM10 might not be supported in an unlicensed system.

For some embodiments, a Channel State Information Reference Signal (CSI-RS) configuration Zero Power (ZP) ID parameter (e.g., “csi-RS-ConfigZPId”) may be optional, depending upon an eNB's implementation for puncturing ePDCCH or not, and a UE may detect it without puncture information.

In some embodiments, the repetition times of an associated PDSCH may be configured by an eNB through higher-layer signaling. For example, different repetition times may be configured for different entries; for example, one repetition may be configured in one scheduling information list parameter (e.g., “schedulingInforList”). In various embodiments, repetition for paging, Random Access (RA), and/or SI may be different

For some embodiments, a PDCCH candidate reductions parameter (e.g., “pdcch-candidateReductions”) may not be configured for CSS.

Some embodiments may pertain to candidate search spaces. In some embodiments, legacy PDCCH may be in accordance with Table 2 below, an may correspond with 12 blind detection for CSS (6 corresponding with DCI format 1A and/or 6 corresponding with DCI format 1C).

TABLE 2
PDCCH candidates monitored by a UE

| Search space Sₖ^{(L)} | | | Number of PDCCH |
|---|---|---|---|
| Type | Aggregation level L | Size [in CCEs] | candidates M^{(L)} |
| UE-specific | 1 | 6 | 6 |
| | 2 | 12 | 6 |
| | 4 | 8 | 2 |
| | 8 | 16 | 2 |
| Common | 4 | 16 | 4 |
| | 8 | 16 | 2 |

In some embodiments, the number of candidates in CSS ePDCCH may be the same as, or smaller than, in legacy CSS PDCCH.

Some embodiments may pertain to support for 16 RBs for CSS ePDCCH. In various embodiments, a maximum of 16 RBs may be configured for CSS ePDCCH.

A variety of embodiments may incorporate merely DCI Format 1A.

In some embodiments, an ePDCCH resource configuration may have already been configured by an eNB through higher-layer signaling. Candidates may include:
AL=64, one candidate, DCI format 1A; and
AL=32, two candidates, DCI format 1A.

For some embodiments, an ePDCCH resource may be jointly encoded for blind detection, where the ePDCCH resource for gap 1 and gap 2 may be allocated at separate physical resources. Candidates (which may be 9 in total) may include:
AL=64, one candidate, DCI format 1A, localized VRB
AL=64, one candidate, DCI format 1A, distributed VRB, N_{gap,1}
AL=64, one candidate, DCI format 1A, distributed VRB, N_{gap,2}
AL=32, two candidate, DCI format 1A, localized VRB
AL=32, two candidate, DCI format 1A, distributed VRB, N_{gap,1}
AL=32, two candidate, DCI format 1A, distributed VRB, N_{gap,2}

In some embodiments, an ePDCCH resource may be jointly encoded for blind detection, where the ePDCCH resource for gap 1 and gap 2 are allocated at the same physical resources. Candidates (which may be 6 in total) may include:
AL=64, one candidate, DCI format 1A, localized VRB
AL=64, one candidate, DCI format 1A, distributed VRB, N_{gap,1}/N_{gap,1}
AL=32, two candidate, DCI format 1A, localized VRB
AL=32, two candidate, DCI format 1A, distributed VRB, N_{gap,1}/N_{gap,2}

Some embodiments may pertain to PRB allocation for CSS ePDCCH in a candidate search. In some embodiments, an ePDCCH resource for localized VRB can include:
pre-defined contiguous PRBs at one edge (e.g., 16 PRBs from 0 to 15)
pre-defined contiguous PRBs at two edges (e.g., 8 PRBs from 0 to 7, and/or 8 RBs from 92 to 99)
   PRBs for CSS ePDCCH May be Configured by One or More eNBs.

For some embodiments, an ePDCCH resource for distributed VRB when N_{gap,1} and N_{gap,2} pertain to the same resources may include:
pre-defined PRBs (e.g., PRB 0˜2, PRB 24˜26, PRB69˜71, PRB 93˜95, PRB 96˜99)
   PRBs for CSS ePDCCH may be configured by one or more eNBs. If gap1 and/or gap2 share the same PRBs for ePDCCH (e.g., VRB 12˜83), there may be 72 RBs.

TABLE 3
N_{gap, 1} and N_{gap, 2} share the same physical RBs for CSS ePDCCH

| | N_{gap, 2} | | N_{gap, 1} | |
|---|---|---|---|---|
| PRB | VRB index | VRB index | VRB index | VRB index |
| index | at the 1^{st} slot | at the 2^{nd} slot | at the 1^{st} slot | at the 2^{nd} slot |
| 0 | 0 | 2 | 0 | 2 |
| 1 | 4 | 6 | 4 | 6 |
| 2 | 8 | 10 | 8 | 10 |
| . . . | . . . | . . . | . . . | . . . |
| 24 | 3 | 1 | 1 | 3 |
| 25 | 7 | 5 | 5 | 7 |
| 26 | 11 | 9 | 9 | 11 |
| . . . | . . . | . . . | . . . | . . . |
| 69 | 84 | 86 | 86 | 84 |
| 70 | 88 | 90 | 90 | 88 |
| 71 | 92 | 94 | 94 | 92 |
| . . . | . . . | . . . | . . . | . . . |
| 93 | 87 | 85 | 87 | 85 |
| 94 | 91 | 89 | 91 | 89 |
| 95 | 95 | 93 | 95 | 93 |

In some embodiments, an ePDCCH resource for distributed VRB when N_{gap,1} and N_{gap,2} pertain to different resource blocks may include:
pre-defined PRBs for N_{gap,1} (e.g., PRB 0˜2, PRB 24˜26, PRB48˜50, PRB 72˜74, PRB 96˜99; which may correspond to VRB 0˜11; alternatively, a PRB corresponding to VRB 84˜95 may be configured; for example, 84 VRBs may be configured)
pre-defined PRBs for N_{gap,2}, (e.g., PRB 0˜2, PRB8˜10, PRB 16˜18, PRB 24˜26, PRB 96˜99; which may correspond to VRB 0˜11; alternatively, a PRB corresponding to VRB 84˜95 may be configured; for example, 84 VRBs may be configured)

TABLE 4
an example of distributed VRB configuration

N_{gap, 1}

| | VRB index | VRB index |
|---|---|---|
| PRB index | at the 1^{st} slot | at the 2^{nd} slot |
| 0 | 0 | 0 |
| 1 | 4 | 4 |
| 2 | 8 | 8 |
| . . . | . . . | . . . |
| 24 | 1 | 1 |
| 25 | 5 | 5 |
| 26 | 9 | 9 |
| . . . | . . . | . . . |
| 48 | 2 | 2 |
| 49 | 6 | 6 |
| 50 | 10 | 10 |
| . . . | . . . | . . . |
| 72 | 3 | 3 |
| 73 | 7 | 7 |
| 74 | 11 | 11 |
| . . . | . . . | . . . |
| 96 | | |
| 97 | | |
| 98 | | |
| 99 | | |

A variety of embodiments may incorporate DCI Format 1A and DCI Format 1C.

In some embodiments, an ePDCCH resource configuration may have already been configured by an eNB through higher-layer signaling. Candidates (which may total 7 or 9) may include:
AL=64, one candidates, DCI format 1A
AL=32, two candidates, DCI format 1A
AL=32, two candidates, DCI format 1C
AL=16, two or four candidates, DCI format 1C

For some embodiments, an ePDCCH resource configuration may have already been configured by an eNB through higher-layer signaling. Candidates, which may be transparent to DCI format, may include:
AL=64, one candidate
AL=32, two candidates
AL=16, two or three or four candidates

In some embodiments, an ePDCCH resource may be jointly encoded for blind detection, in which an ePDCCH resource for gap 1 and gap 2 may be allocated at separate physical resources, and one or more candidates may be searched from a set of candidates which may include:
AL=64, one candidate, DCI format 1A, localized VRB
AL=64, one candidate, DCI format 1A, distributed VRB, N_{gap,1}
AL=64, one candidate, DCI format 1A, distributed VRB, N_{gap,2}
AL=32, two candidate, DCI format 1A, localized VRB
AL=32, two candidate, DCI format 1A, distributed VRB, N_{gap,1}
AL=32, two candidate, DCI format 1A, distributed VRB, N_{gap,2}
AL=32, two candidate, DCI format 1C, distributed VRB, N_{gap,1}
AL=32, two candidate, DCI format 1C, distributed VRB, N_{gap,2}
AL=16, four candidates, DCI format 1C, distributed VRB, N_{gap,1}
AL=16, four candidates, DCI format 1C, distributed VRB, N_{gap,2}

For some embodiments, a ePDCCH resource may be jointly encoded for blind detection, in which an ePDCCH resource for gap 1 and gap 2 may be allocated at the same physical resources, and one or more candidates may be searched from a set of candidates which may include:
AL=64, one candidate, DCI format 1A, localized VRB
AL=64, one candidate, DCI format 1A, distributed VRB
AL=32, two candidate, DCI format 1A, localized VRB
AL=32, two candidate, DCI format 1A, distributed VRB
AL=32, two candidate, DCI format 1C, distributed VRB
AL=16, four candidates, DCI format 1C, distributed VRB

Some embodiments may pertain to support for 32 RBs for CSS ePDCCH.

In some embodiments, a maximum of 32 RBs may be utilized for CSS ePDCCH. The candidate number at 16 RBs may be doubled.

For some embodiments, the candidate may merely be DCI format 1A, and may include:
AL=64, two candidates
AL=32, two or four candidates
AL=16, two or four or eight candidates

In some embodiments, the candidate may be DCI format 1A and DCI format 1C, and may include:
AL=64, two candidates for DCI format 1A
AL=32, four candidates for DCI format 1A
AL=32, two candidates for DCI format 1C
AL=16, four candidates for DCI format 1C

For some embodiments, the candidate may be transparent to DCI format, and may include:
AL=64, two candidates
AL=32, two candidates
AL=16, two candidates

In some embodiments, for DCI format 1A, an ePDCCH resource for gap 1 and gap 2 may be allocated at the same physical resource. Candidates (which may be 6 in total) may include:
AL=64, two candidates, DCI format 1A, localized VRB
AL=64, two candidates, DCI format 1A, distributed VRB, N_{gap,1}/N_{gap,1}
AL=32, four candidates, DCI format 1A, localized VRB
AL=32, four candidates, DCI format 1A, distributed VRB, N_{gap,1}/N_{gap,2}

In various embodiments, a CSS of Type 0 (which may be specific to SIB1) and a CSS of Type 1 (which may be specific for other CSS) may be defined in a variety of ways.

In some embodiments, a candidate for Type 0 may be either (AL=64, format 1A) or (AL=32 format 1C), for either localized VRB or distributed VRB.

For some embodiments, two candidates for type 0 may be selected from:
one (AL=64, format 1A), and one (AL=32, format 1A), for either localized VRB or distributed VRB;
one (AL=32, format 1C), and one (AL=16, format 1C), for either localized VRB or distributed VRB; or
one (AL=64, format 1A), and one (AL=32, format 1C), for either localized VRB or distributed VRB

In some embodiments, three candidates for type 0 may be selected from:
one (AL=64, format 1A), and two (AL=32, format 1A), for either localized VRB or distributed VRB; or
one (AL=32, format 1C), and two (AL=16, format 1C), for either localized VRB or distributed VRB

For some embodiments, four candidates for type 0 may be selected from:
one (AL=64, format 1A), and one (AL=32, format 1A), and one (AL=32, format 1C), and one (AL=16, format 1C), for either localized VRB or distributed VRB

In some embodiments, six candidates for type 0 may be selected from:
one (AL=64, format 1A), and two (AL=32, format 1A), and one (AL=32, format 1C), and two (AL=16, format 1C), for either localized VRB or distributed VRB

For some embodiments, six candidates for type 1 may be selected from:
one (AL=64, format 1A)+two (AL=32, format 1A)+one (AL=32, format 1C)+two (AL=16, format 1A)

In some embodiments, eight candidates for type 1 may be selected from:
two (AL=64, format 1A)+two (AL=32, format 1A)+two (AL=32, format 1C)+two (AL=16, format 1C)

For some embodiments, ten candidates for type 1 may be selected from:
two (AL=64, format 1A)+three (AL=32, format 1A)+two (AL=32, format 1C)+three (AL=16, format 1A)

In some embodiments, for type 0 CSS, a candidates number at a localized hard-coded ePDCCH may be different from a distributed hard-coded ePDCCH (e.g., 1 for localized and 2 for distributed).

For some embodiments, the candidate location at different ePDCCH sets, when two sets are configured, may be in accordance with Table 5 below (one or more rows of which may pertain to Type 0 CSS).

TABLE 5
example candidate locations

| | [M₀^{(L)} M₁^{(L)}] |
|---|---|
| AL = 64, DCI format 1A | 1 for set 0 + set 1 |
| AL = 32, DCI format 1A | [1 0] or [0, 1] for one BD or |
| | [1, 1] for two BDs |
| AL = 32, DCI format 1C | [1 0] or [0 1] for one BD or |
| | [1 1] for two BDs |
| AL = 16, DCI format 1C | [1 0] or [0 1] for one BD or |
| | [2 0] or [0 2] or [1 1] for two BDs |

Where Mᵢ^{(L)} may be candidate numbers at a set i.

In some embodiments, candidate locations at different ePDCCH sets, when four sets are configured, may be in accordance with Table 6 below (one or more rows of which may pertain to Type 1 CSS).

TABLE 6
example candidate locations

| | [M₀^{(L)} M₁^{(L)} M₂^{(L)} M₃^{(L)}] |
|---|---|
| AL = 64, format 1A | [1, 1] for [set 0 + set 1, set 2 + |
| | set 3] for two BDs |
| AL = 32, format 1A | 2 BDs: one candidate on any |
| | two sets (e.g., [1 1 0 0], or [1 0 |
| | 1 0]) |
| | 3 BDs: one candidate on any |
| | three sets within the |
| | configured four sets |
| AL = 32, format 1C | 2 BDs: one candidate on any |
| | two sets (e.g., [1 0 1 0], or [1 1 |
| | 0 0]) |
| AL = 16, format 1C | 2 BDs: one candidate on any |
| | two sets (e.g., [1 1 0 0], or [1 0 |
| | 1 0]); or |
| | two candidates within any one |
| | set (e.g., [2 0 0 0]) |
| | 3 BDs: one candidate on any |
| | three sets; or |
| | two candidates on any one set, |
| | and one candidate on the |
| | remaining sets (e.g., [2 1 0 0]) |

Some embodiments may pertain to further enhanced eCCE. In some embodiments, an RE mapping to eCCE may reuse a legacy rule (e.g., similar to incumbent LTE system), and the mapping may be restricted within one set. For some embodiments, for AL<=64, the candidates may be confined within one set, while for AL=64, the association rule may be pre-defined or may be configured by an eNB through higher-layer signaling. For example, a set 0 may be associated with a set 1, a set 2 may be associated with set 3. When performing AL=64, the ePDCCH on set 0 may be repeated on set 1.

In some embodiments, a further enhanced eCCE may be concatenated by eCCEs of two sets in a distributed manner, or in a localized manner. A eCCE on set 0 may be numbered as {#eCCE_{0,0} #eCCE_{0,1} . . . #eCCE_{0,31}} and an eCCE on set 1 may be numbered as {#eCCE_{1,0} #eCCE_{1,1} . . . 190 eCCE_{1,31}}. An aggregated CCE (e.g., an feCCE) may be {#eCCE_{0,0} #eCCE_{0,1} . . . #eCCE_{0,31}}, {#eCCE_{1,0} #eCCE_{1,1} . . . #eCCE_{1,31}}, or {#eCCE_{0,0} #eCCE_{1,0} #eCCE_{0,1} #eCCE_{1,1} . . . #eCCE_{0,31} #eCCE_{1,31}}.

For some embodiments, 8 RBs plus 8 RBs to support AL=64 may be repeated by 2 AL=32, where AL=32 may correspond to a reuse of a legacy physical layer procedure.

Some embodiments may pertain to SIB Period. In some embodiments, for SI transmission, a scheduling Information List parameter (e.g., “schedulingInfoList”) may be configured by an eNB via SIB1 or SIB 2 (SIB2).

For some embodiments, for WCE, a period and/or SIB type may be disposed to being configured. An SI periodicity/SIB mapping info parameter (e.g., “si_periodicity/sib_MappingInfo”) may be the same as for legacy non-WCE, while an SI periodicity/SIB mapping info parameter may be separated as per legacy non-WCE.

In some embodiments, an SI window length parameter (e.g., “si_WindowLength”) may be configured as follows. First, a SI window length parameter (e.g., “si_WindowLength”) may be either the as, or different from, legacy non-WCE. When timing repetition on PDSCH is applied, the SI window length parameter may be utilized to constraint ePDCCH and a starting PDSCH subframe. Alternatively, the SI window1 length parameter may be utilized to constraint an ending PDSCH subframe. In the later case, PDSCH for SI might not be scheduled later than N_{end}−Nᵣₑₚ+1, where N_{end} may be an ending subframe of one window, and Nᵣₑₚ may be a repetition number.

Some embodiments may pertain to Paging period. In some embodiments, for WCE, a starting subframe may be calculated based on PO and/or PF, and repetition may be indicated by DCI or may be configured by RRC.

Some embodiments may pertain to other details. In some embodiments, partial subframes might not be allowed for ePDCCH CSS. Since PDSCH may start at the same subframe as DCI, if repetition is applied, available resource at two different subframes may not be difficult for MCS selection.

For some embodiments, with respect to cross-carrier scheduling, partial subframes might not be allowed for ePDCCH CSS. Since PDSCH may start at the same subframe as DCI, if repetition is applied, available resource at two different subframes may not be difficult for MCS selection.

In some embodiments, one or more entries may be supported in CSS ePDCCH, as follows:
DCI scrambled by SI-RNTI
DCI scrambled by PI-RNTI
DCI scrambled by RA-RNTI
DCI scrambled by TPC-PUCCH-RNTI
DCI scrambled by TPC-PUSCH-RNTI

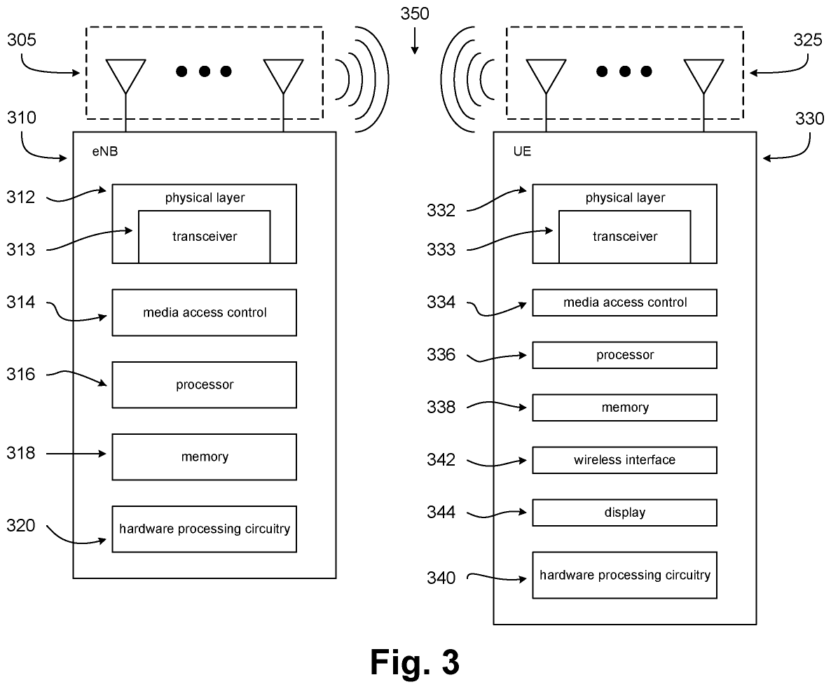

FIG. 3 illustrates an eNB and a UE, in accordance with some embodiments of the disclosure. FIG. 3 includes block diagrams of an eNB 310 and a UE 330 which are operable to co-exist with each other and other elements of an LTE network. High-level, simplified architectures of eNB 310 and UE 330 are described so as not to obscure the embodiments. It should be noted that in some embodiments, eNB 310 may be a stationary non-mobile device.

eNB 310 is coupled to one or more antennas 305, and UE 330 is similarly coupled to one or more antennas 325. However, in some embodiments, eNB 310 may incorporate or comprise antennas 305, and UE 330 in various embodiments may incorporate or comprise antennas 325.

In some embodiments, antennas 305 and/or antennas 325 may comprise one or more directional or omni-directional antennas, including monopole antennas, dipole antennas, loop antennas, patch antennas, microstrip antennas, coplanar wave antennas, or other types of antennas suitable for transmission of RF signals. In some MIMO (multiple-input and multiple output) embodiments, antennas 305 are separated to take advantage of spatial diversity.

eNB 310 and UE 330 are operable to communicate with each other on a network, such as a wireless network. eNB 310 and UE 330 may be in communication with each other over a wireless communication channel 350, which has both a downlink path from eNB 310 to UE 330 and an uplink path from UE 330 to eNB 310.

As illustrated in FIG. 3, in some embodiments, eNB 310 may include a physical layer circuitry 312, a MAC (media access control) circuitry 314, a processor 316, a memory 318, and a hardware processing circuitry 320. A person skilled in the art will appreciate that other components not shown may be used in addition to the components shown to form a complete eNB.

In some embodiments, physical layer circuitry 312 includes a transceiver 313 for providing signals to and from UE 330. Transceiver 313 provides signals to and from UEs or other devices using one or more antennas 305. In some embodiments, MAC circuitry 314 controls access to the wireless medium. Memory 318 may be, or may include, a storage media/medium such as a magnetic storage media (e.g., magnetic tapes or magnetic disks), an optical storage media (e.g., optical discs), an electronic storage media (e.g., conventional hard disk drives, solid-state disk drives, or flash-memory-based storage media), or any tangible storage media or non-transitory storage media. Hardware processing circuitry 320 may comprise logic devices or circuitry to perform various operations. In some embodiments, processor 316 and memory 318 are arranged to perform the operations of hardware processing circuitry 320, such as operations described herein with reference to logic devices and circuitry within eNB 310 and/or hardware processing circuitry 320.

Accordingly, in some embodiments, eNB 310 may be a device comprising an application processor, a memory, one or more antenna ports, and an interface for allowing the application processor to communicate with another device.

As is also illustrated in FIG. 3, in some embodiments, UE 330 may include a physical layer circuitry 332, a MAC circuitry 334, a processor 336, a memory 338, a hardware processing circuitry 340, a wireless interface 342, and a display 344. A person skilled in the art would appreciate that other components not shown may be used in addition to the components shown to form a complete UE.

In some embodiments, physical layer circuitry 332 includes a transceiver 333 for providing signals to and from eNB 310 (as well as other eNBs). Transceiver 333 provides signals to and from eNBs or other devices using one or more antennas 325. In some embodiments, MAC circuitry 334 controls access to the wireless medium. Memory 338 may be, or may include, a storage media/medium such as a magnetic storage media (e.g., magnetic tapes or magnetic disks), an optical storage media (e.g., optical discs), an electronic storage media (e.g., conventional hard disk drives, solid-state disk drives, or flash-memory-based storage media), or any tangible storage media or non-transitory storage media. Wireless interface 342 may be arranged to allow the processor to communicate with another device. Display 344 may provide a visual and/or tactile display for a user to interact with UE 330, such as a touch-screen display. Hardware processing circuitry 340 may comprise logic devices or circuitry to perform various operations. In some embodiments, processor 336 and memory 338 may be arranged to perform the operations of hardware processing circuitry 340, such as operations described herein with reference to logic devices and circuitry within UE 330 and/or hardware processing circuitry 340.

Accordingly, in some embodiments, UE 330 may be a device comprising an application processor, a memory, one or more antennas, a wireless interface for allowing the application processor to communicate with another device, and a touch-screen display.

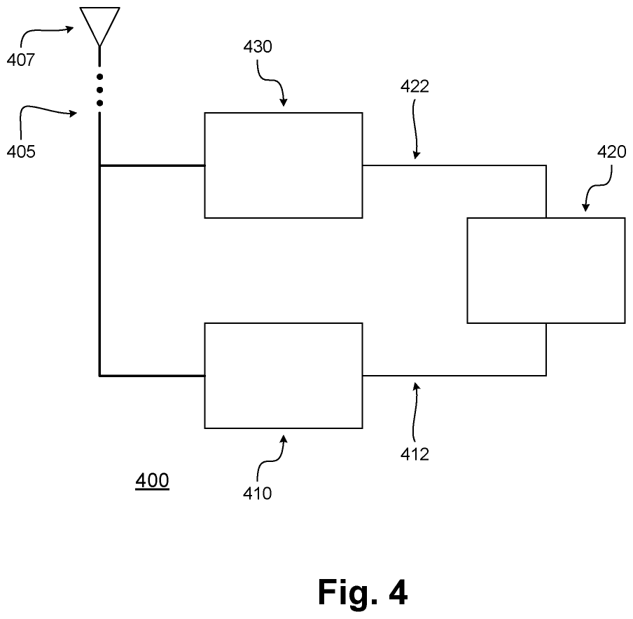

Elements of FIG. 3, and elements of other figures having the same names or reference numbers, can operate or function in the manner described herein with respect to any such figures (although the operation and function of such elements is not limited to such descriptions). For example, FIGS. 4 and 7-8 also depict embodiments of eNBs, hardware processing circuitry of eNBs, UEs, and/or hardware processing circuitry of UEs, and the embodiments described with respect to FIG. 3 and FIGS. 4 and 7-8 can operate or function in the manner described herein with respect to any of the figures.

In addition, although eNB 310 and UE 330 are each described as having several separate functional elements, one or more of the functional elements may be combined and may be implemented by combinations of software-configured elements and/or other hardware elements. In some embodiments of this disclosure, the functional elements can refer to one or more processes operating on one or more processing elements. Examples of software and/or hardware configured elements include Digital Signal Processors (DSPs), one or more microprocessors, DSPs, Field-Programmable Gate Arrays (FPGAs), Application Specific Integrated Circuits (ASICs), Radio-Frequency Integrated Circuits (RFICs), and so on.

FIG. 4 illustrates hardware processing circuitries for a UE for implementing CSS for ePDCCH, in accordance with some embodiments of the disclosure. With reference to FIG. 3, a UE may include various hardware processing circuitries discussed herein (such as hardware processing circuitry 400 of FIG. 4), which may in turn comprise logic devices and/or circuitry operable to perform various operations. For example, in FIG. 3, UE 330 (or various elements or components therein, such as hardware processing circuitry 340, or combinations of elements or components therein) may include part of, or all of, these hardware processing circuitries.

In some embodiments, one or more devices or circuitries within these hardware processing circuitries may be implemented by combinations of software-configured elements and/or other hardware elements. For example, processor 336 (and/or one or more other processors which UE 330 may comprise), memory 338, and/or other elements or components of UE 330 (which may include hardware processing circuitry 340) may be arranged to perform the operations of these hardware processing circuitries, such as operations described herein with reference to devices and circuitry within these hardware processing circuitries. In some embodiments, processor 336 (and/or one or more other processors which UE 330 may comprise) may be a baseband processor.

Returning to FIG. 4, an apparatus of UE 330 (or another UE or mobile handset), which may be operable to communicate with one or more eNBs on a wireless network, may comprise hardware processing circuitry 400. In some embodiments, hardware processing circuitry 400 may comprise one or more antenna ports 405 operable to provide various transmissions over a wireless communication channel (such as wireless communication channel 350). Antenna ports 405 may be coupled to one or more antennas 407 (which may be antennas 325). In some embodiments, hardware processing circuitry 400 may incorporate antennas 407, while in other embodiments, hardware processing circuitry 400 may merely be coupled to antennas 407.

Antenna ports 405 and antennas 407 may be operable to provide signals from a UE to a wireless communications channel and/or an eNB, and may be operable to provide signals from an eNB and/or a wireless communications channel to a UE. For example, antenna ports 405 and antennas 407 may be operable to provide transmissions from UE 330 to wireless communication channel 350 (and from there to eNB 310, or to another eNB). Similarly, antennas 407 and antenna ports 405 may be operable to provide transmissions from a wireless communication channel 350 (and beyond that, from eNB 310, or another eNB) to UE 330.

Hardware processing circuitry 400 may comprise various circuitries operable in accordance with the various embodiments discussed herein. With reference to FIG. 4, hardware processing circuitry 400 may comprise a first circuitry 410, a second circuitry 420, and/or a third circuitry 430.

In a variety of embodiments, first circuitry 410 may be operable to process one or more configuring transmissions from the eNB carrying one or more parameters for CSS for WCE mode. Second circuitry 420 may be operable to establish a CSS encompassing one or more ePDCCH candidate transmissions based upon the one or more parameters for CSS for WCE mode. First circuitry 410 may be operable to provide information pertaining to the one or more parameters for CSS for WCE mode to second circuitry 420 and/or (through second circuitry 420) to third circuitry 430 via an interface 412. Third circuitry 430 may be operable to monitor the one or more ePDCCH candidate transmissions for DCI in accordance with the one or more parameters for CSS for WCE mode. Second circuitry 420 may be operable to provide information pertaining to the one or more ePDCCH candidate transmissions to third circuitry 430 via an interface 422. Hardware processing circuitry 400 may comprise an interface for receiving the one or more configuring transmissions and the one or more ePDCCH candidate transmissions from a receiving circuitry.

In some embodiments, the one or more higher-layer signaling transmissions may carry an indicator of a set of PRBs for CSS. For some embodiments, the set of PRBs for CSS may overlap a set of PRBs for a UESS. In some embodiments, the set of PRBs for CSS might not overlap a set of PRBs for a UESS. For some embodiments, one or more eCCE indices may be derived in accordance with the eCCE index derivation rule:

$$L \{ ( {Y}_{p , k} + ⌊ \frac{m \cdot {N}_{ECCE , p , k}}{L \cdot {M}_{p}^{( L )}} ⌋ + b ) mod ⌊ {N}_{ECCE , p , k} / L ⌋ \} + i$$

For some embodiments, a WCE mode indicator may be provided by a PRACH transmission, a higher-layer signaling transmission, or a DCI transmission, the WCE mode indicator having a first value indicating normal mode and a second value indicating WCE mode, and the one or more ePDCCH candidate transmissions may be monitored for DCI upon the WCE mode indicator having the second value. In some embodiments, a subframe for the one or more ePDCCH candidate transmissions in the CSS may depend upon a SI window, a paging occasion, and/or a DTxW. For some embodiments, the one or more configuring transmissions may comprise a Radio Resource Control transmission, a MIB transmission, and/or a SIB transmission. In some embodiments, the one or more parameters for CSS for WCE mode may include a resource block assignment indicator, a number of PRBs indicator, and/or a DM-RS scrambling sequence indicator.

In a variety of embodiments, first circuitry 410 may be operable to process one or more configuring transmissions from the eNB carrying one or more parameters for CSS for WCE mode. Second circuitry 420 may be operable to determine a CSS encompassing one or more ePDCCH candidate transmissions based upon the one or more parameters for CSS for WCE mode. First circuitry 410 may be operable to provide information pertaining to the one or more parameters for CSS for WCE mode to second circuitry 420 and/or (through second circuitry 420) to third circuitry 430 via an interface 412. Third circuitry 430 may be operable to monitor the CSS for DCI based upon the one or more parameters for CSS for WCE mode. Second circuitry 420 may be operable to provide information pertaining to the CSS to third circuitry 430 via an interface 422. Hardware processing circuitry 400 may comprise an interface for receiving the one or more configuring transmissions and the one or more ePDCCH candidate transmissions from a receiving circuitry.

In some embodiments, the one or more parameters for CSS for WCE mode may comprise an indicator of a maximum number of 32 RBs for CSS. For some embodiments, the one or more parameters for CSS for WCE mode may comprise an ePDCCH candidate transmission configuration indicator, specifying two candidates for DCI format 1A corresponding to an AL of 64, and/or two candidates for DCI format 1C corresponding to an AL of 32. In some embodiments, a DCI of the one or more ePDCCH candidate transmissions may be scrambled by an RNTI selected from an SI-RNTI, a PI-RNTI, an RA-RNTI, or a TPC-PUCCH-RNTI.

For some embodiments, the one or more configuring transmissions may comprise a SIB1 transmission, and the one or more parameters for CSS for WCE mode may include a scheduling information indicator. In some embodiments, the one or more parameters for CSS for WCE mode may comprise an ePDCCH candidate transmission configuration indicator for a CSS for SIB1, specifying: one candidate for DCI format 1A corresponding to an AL of 64, and one candidate for DCI format 1A corresponding to an AL of 32; and/or one candidate for DCI format 1C corresponding to an AL of 32, and one candidate for DCI format 1A corresponding to an AL of 16.

In some embodiments, first circuitry 410, second circuitry 420, and/or third circuitry 430 may be implemented as separate circuitries. In other embodiments, first circuitry 410, second circuitry 420, and/or third circuitry 430 may be combined and implemented together in a circuitry without altering the essence of the embodiments.

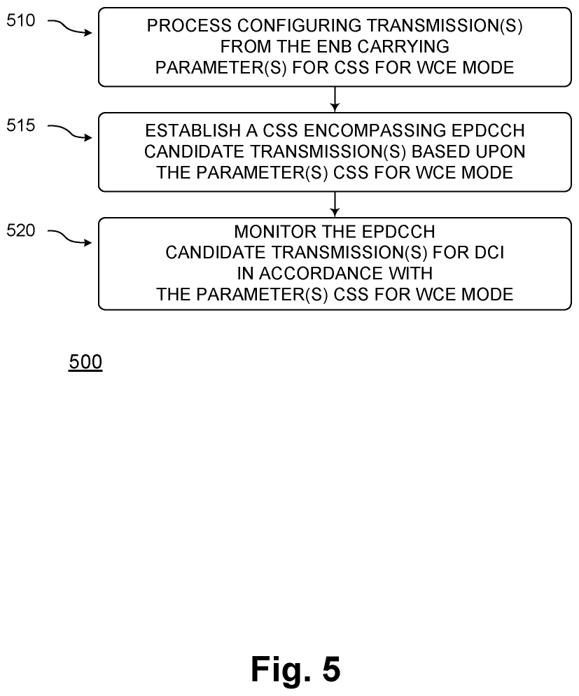

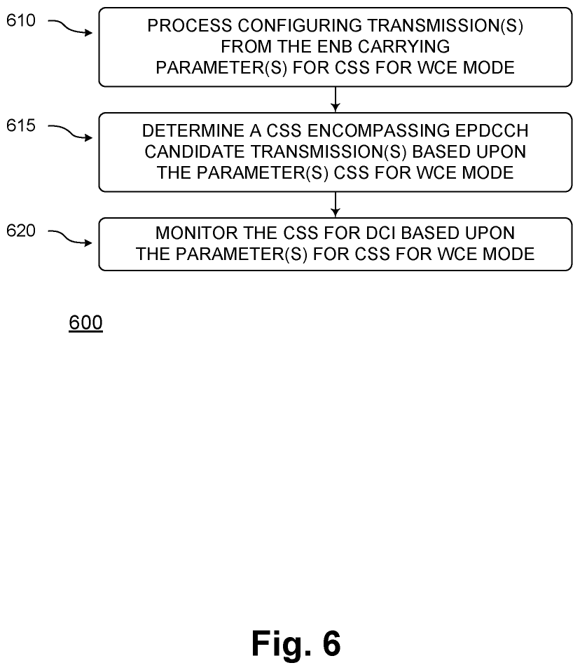

FIG. 5 illustrates methods for a UE for implementing CSS for ePDCCH, in accordance with some embodiments of the disclosure. FIG. 6 illustrates methods for a UE for implementing CSS for ePDCCH, in accordance with some embodiments of the disclosure. With reference to FIG. 3, methods that may relate to UE 330 and hardware processing circuitry 340 are discussed herein. Although the actions in method 500 of FIG. 5 and method 600 of FIG. 6 are shown in a particular order, the order of the actions can be modified. Thus, the illustrated embodiments can be performed in a different order, and some actions may be performed in parallel. Some of the actions and/or operations listed in FIGS. 5 and 6 are optional in accordance with certain embodiments. The numbering of the actions presented is for the sake of clarity and is not intended to prescribe an order of operations in which the various actions must occur. Additionally, operations from the various flows may be utilized in a variety of combinations.

Moreover, in some embodiments, machine readable storage media may have executable instructions that, when executed, cause UE 330 and/or hardware processing circuitry 340 to perform an operation comprising the methods of FIGS. 5 and 6. Such machine readable storage media may include any of a variety of storage media, like magnetic storage media (e.g., magnetic tapes or magnetic disks), optical storage media (e.g., optical discs), electronic storage media (e.g., conventional hard disk drives, solid-state disk drives, or flash-memory-based storage media), or any other tangible storage media or non-transitory storage media.

In some embodiments, an apparatus may comprise means for performing various actions and/or operations of the methods of FIGS. 5 and 6.

Returning to FIG. 5, various methods may be in accordance with the various embodiments discussed herein. A method 500 may comprise a processing 510, an establishing 515, and a monitoring 520.

In processing 510, one or more configuring transmissions from the eNB carrying one or more parameters for CSS for WCE mode may be processed. In establishing 515, a CSS encompassing one or more ePDCCH candidate transmissions may be established based upon the one or more parameters for CSS for WCE mode. In monitoring 520, the one or more ePDCCH candidate transmissions may be monitored for DCI in accordance with the one or more parameters for CSS for WCE mode.

In some embodiments, the one or more higher-layer signaling transmissions may carry an indicator of a set of PRBs for CSS. For some embodiments, the set of PRBs for CSS may overlap a set of PRBs for a UESS. In some embodiments, the set of PRBs for CSS might not overlap a set of PRBs for a UESS. For some embodiments, one or more eCCE indices may be derived in accordance with the eCCE index derivation rule:

$$L \{ ( {Y}_{p , k} + ⌊ \frac{m \cdot {N}_{ECCE , p , k}}{L \cdot {M}_{p}^{( L )}} ⌋ + b ) mod ⌊ {N}_{ECCE , p , k} / L ⌋ \} + i$$

For some embodiments, a WCE mode indicator may be provided by a PRACH transmission, a higher-layer signaling transmission, or a DCI transmission, the WCE mode indicator having a first value indicating normal mode and a second value indicating WCE mode, and the one or more ePDCCH candidate transmissions may be monitored for DCI upon the WCE mode indicator having the second value. In some embodiments, a subframe for the one or more ePDCCH candidate transmissions in the CSS may depend upon a SI window, a paging occasion, and/or a DTxW. For some embodiments, the one or more configuring transmissions may comprise a Radio Resource Control transmission, a MIB transmission, and/or a SIB transmission. In some embodiments, the one or more parameters for CSS for WCE mode may include a resource block assignment indicator, a number of PRBs indicator, and/or a DM-RS scrambling sequence indicator.

Returning to FIG. 6, various methods may be in accordance with the various embodiments discussed herein. A method 600 may comprise a processing 610, a determining 615, and a monitoring 620.

In processing 610, one or more configuring transmissions from the eNB carrying one or more parameters for CSS for WCE mode may be processed. In determining 615, a CSS encompassing one or more ePDCCH candidate transmissions may be determined based upon the one or more parameters for CSS for WCE mode. In monitoring 620, the CSS may be monitored for DCI based upon the one or more parameters for CSS for WCE mode.

In some embodiments, the one or more parameters for CSS for WCE mode may comprise an indicator of a maximum number of 32 RBs for CSS. For some embodiments, the one or more parameters for CSS for WCE mode may comprise an ePDCCH candidate transmission configuration indicator, specifying two candidates for DCI format 1A corresponding to an AL of 64, and/or two candidates for DCI format 1C corresponding to an AL of 32. In some embodiments, a DCI of the one or more ePDCCH candidate transmissions may be scrambled by an RNTI selected from an SI-RNTI, a PI-RNTI, an RA-RNTI, or a TPC-PUCCH-RNTI.

For some embodiments, the one or more configuring transmissions may comprise a SIB1 transmission, and the one or more parameters for CSS for WCE mode may include a scheduling information indicator. In some embodiments, the one or more parameters for CSS for WCE mode may comprise an ePDCCH candidate transmission configuration indicator for a CSS for SIB1, specifying: one candidate for DCI format 1A corresponding to an AL of 64, and one candidate for DCI format 1A corresponding to an AL of 32; and/or one candidate for DCI format 1C corresponding to an AL of 32, and one candidate for DCI format 1A corresponding to an AL of 16.

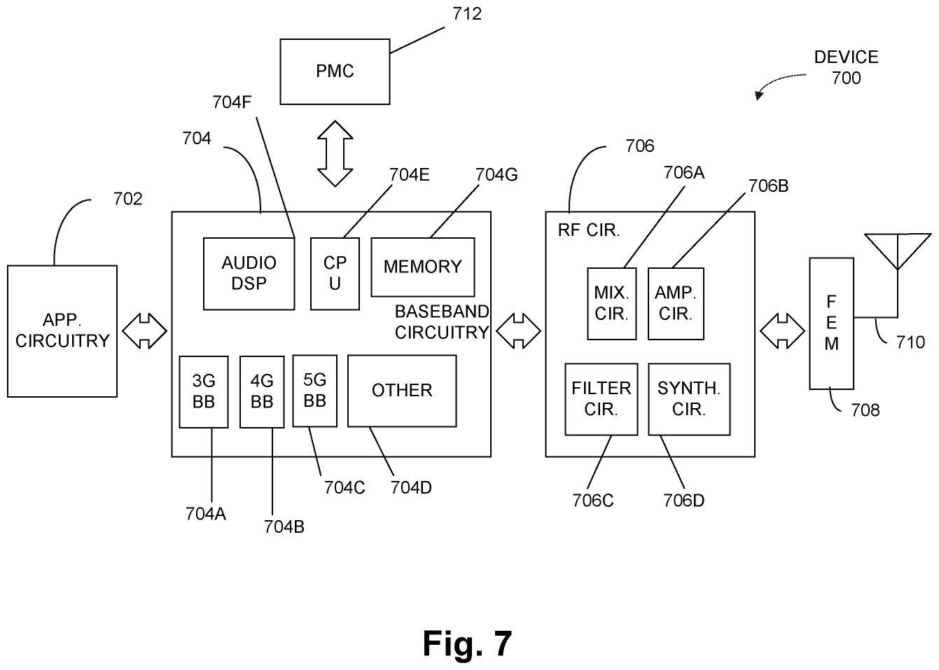

FIG. 7 illustrates example components of a device, in accordance with some embodiments of the disclosure. In some embodiments, the device 700 may include application circuitry 702, baseband circuitry 704, Radio Frequency (RF) circuitry 706, front-end module (FEM) circuitry 708, one or more antennas 710, and power management circuitry (PMC) 712 coupled together at least as shown. The components of the illustrated device 700 may be included in a UE or a RAN node. In some embodiments, the device 700 may include less elements (e.g., a RAN node may not utilize application circuitry 702, and instead include a processor/controller to process IP data received from an EPC). In some embodiments, the device 700 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 702 may include one or more application processors. For example, the application circuitry 702 may include circuitry such as, but not limited to, one or more single-core or multi-core processors. The processor(s) may include any combination of general-purpose processors and dedicated processors (e.g., graphics processors, application processors, and so on). The processors may be coupled with or may include memory/storage and may be configured to execute instructions stored in the memory/storage to enable various applications or operating systems to run on the device 700. In some embodiments, processors of application circuitry 702 may process IP data packets received from an EPC.

The baseband circuitry 704 may include circuitry such as, but not limited to, one or more single-core or multi-core processors. The baseband circuitry 704 may include one or more baseband processors or control logic to process baseband signals received from a receive signal path of the RF circuitry 706 and to generate baseband signals for a transmit signal path of the RF circuitry 706. Baseband processing circuitry 704 may interface with the application circuitry 702 for generation and processing of the baseband signals and for controlling operations of the RF circuitry 706. For example, in some embodiments, the baseband circuitry 704 may include a third generation (3G) baseband processor 704A, a fourth generation (4G) baseband processor 704B, a fifth generation (5G) baseband processor 704C, or other baseband processor(s) 704D for other existing generations, generations in development or to be developed in the future (e.g., second generation (2G), sixth generation (6G), and so on). The baseband circuitry 704 (e.g., one or more of baseband processors 704A-D) may handle various radio control functions that enable communication with one or more radio networks via the RF circuitry 706. In other embodiments, some or all of the functionality of baseband processors 704A-D may be included in modules stored in the memory 704G and executed via a Central Processing Unit (CPU) 704E. The radio control functions may include, but are not limited to, signal modulation/demodulation, encoding/decoding, radio frequency shifting, and so on. In some embodiments, modulation/demodulation circuitry of the baseband circuitry 704 may include Fast-Fourier Transform (FFT), precoding, or constellation mapping/demapping functionality. In some embodiments, encoding/decoding circuitry of the baseband circuitry 704 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 704 may include one or more audio digital signal processor(s) (DSP) 704F. The audio DSP(s) 704F may include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 704 and the application circuitry 702 may be implemented together such as, for example, on a system on a chip (SOC).

In some embodiments, the baseband circuitry 704 may provide for communication compatible with one or more radio technologies. For example, in some embodiments, the baseband circuitry 704 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 704 is configured to support radio communications of more than one wireless protocol may be referred to as multi-mode baseband circuitry.

RF circuitry 706 may enable communication with wireless networks using modulated electromagnetic radiation through a non-solid medium. In various embodiments, the RF circuitry 706 may include switches, filters, amplifiers, and so on to facilitate the communication with the wireless network. RF circuitry 706 may include a receive signal path which may include circuitry to down-convert RF signals received from the FEM circuitry 708 and provide baseband signals to the baseband circuitry 704. RF circuitry 706 may also include a transmit signal path which may include circuitry to up-convert baseband signals provided by the baseband circuitry 704 and provide RF output signals to the FEM circuitry 708 for transmission.

In some embodiments, the receive signal path of the RF circuitry 706 may include mixer circuitry 706A, amplifier circuitry 706B and filter circuitry 706C. In some embodiments, the transmit signal path of the RF circuitry 706 may include filter circuitry 706C and mixer circuitry 706A. RF circuitry 706 may also include synthesizer circuitry 706D for synthesizing a frequency for use by the mixer circuitry 706A of the receive signal path and the transmit signal path. In some embodiments, the mixer circuitry 706A of the receive signal path may be configured to down-convert RF signals received from the FEM circuitry 708 based on the synthesized frequency provided by synthesizer circuitry 706D. The amplifier circuitry 706B may be configured to amplify the down-converted signals and the filter circuitry 706C may be a low-pass filter (LPF) or band-pass filter (BPF) configured to remove unwanted signals from the down-converted signals to generate output baseband signals. Output baseband signals may be provided to the baseband circuitry 704 for further processing. In some embodiments, the output baseband signals may be zero-frequency baseband signals, although this is not a requirement. In some embodiments, mixer circuitry 706A of the receive signal path may comprise passive mixers, although the scope of the embodiments is not limited in this respect.

In some embodiments, the mixer circuitry 706A of the transmit signal path may be configured to up-convert input baseband signals based on the synthesized frequency provided by the synthesizer circuitry 706D to generate RF output signals for the FEM circuitry 708. The baseband signals may be provided by the baseband circuitry 704 and may be filtered by filter circuitry 706C.

In some embodiments, the mixer circuitry 706A of the receive signal path and the mixer circuitry 706A of the transmit signal path may include two or more mixers and may be arranged for quadrature downconversion and upconversion, respectively. In some embodiments, the mixer circuitry 706A of the receive signal path and the mixer circuitry 706A of the transmit signal path may include two or more mixers and may be arranged for image rejection (e.g., Hartley image rejection). In some embodiments, the mixer circuitry 706A of the receive signal path and the mixer circuitry 706A may be arranged for direct downconversion and direct upconversion, respectively. In some embodiments, the mixer circuitry 706A of the receive signal path and the mixer circuitry 706A of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 706 may include analog-to-digital converter (ADC) and digital-to-analog converter (DAC) circuitry and the baseband circuitry 704 may include a digital baseband interface to communicate with the RF circuitry 706.

In some dual-mode embodiments, a separate radio IC circuitry may be provided for processing signals for each spectrum, although the scope of the embodiments is not limited in this respect.

In some embodiments, the synthesizer circuitry 706D may be a fractional-N synthesizer or a fractional N/N+1 synthesizer, although the scope of the embodiments is not limited in this respect as other types of frequency synthesizers may be suitable. For example, synthesizer circuitry 706D may be a delta-sigma synthesizer, a frequency multiplier, or a synthesizer comprising a phase-locked loop with a frequency divider.

The synthesizer circuitry 706D may be configured to synthesize an output frequency for use by the mixer circuitry 706A of the RF circuitry 706 based on a frequency input and a divider control input. In some embodiments, the synthesizer circuitry 706D may be a fractional N/N+1 synthesizer.

In some embodiments, frequency input may be provided by a voltage controlled oscillator (VCO), although that is not a requirement. Divider control input may be provided by either the baseband circuitry 704 or the applications processor 702 depending on the desired output frequency. In some embodiments, a divider control input (e.g., N) may be determined from a look-up table based on a channel indicated by the applications processor 702.

Synthesizer circuitry 706D of the RF circuitry 706 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 706D may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 706 may include an IQ/polar converter.

FEM circuitry 708 may include a receive signal path which may include circuitry configured to operate on RF signals received from one or more antennas 710, amplify the received signals and provide the amplified versions of the received signals to the RF circuitry 706 for further processing. FEM circuitry 708 may also include a transmit signal path which may include circuitry configured to amplify signals for transmission provided by the RF circuitry 706 for transmission by one or more of the one or more antennas 710. In various embodiments, the amplification through the transmit or receive signal paths may be done solely in the RF circuitry 706, solely in the FEM 708, or in both the RF circuitry 706 and the FEM 708.

In some embodiments, the FEM circuitry 708 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 706). The transmit signal path of the FEM circuitry 708 may include a power amplifier (PA) to amplify input RF signals (e.g., provided by RF circuitry 706), and one or more filters to generate RF signals for subsequent transmission (e.g., by one or more of the one or more antennas 710).

In some embodiments, the PMC 712 may manage power provided to the baseband circuitry 704. In particular, the PMC 712 may control power-source selection, voltage scaling, battery charging, or DC-to-DC conversion. The PMC 712 may often be included when the device 700 is capable of being powered by a battery, for example, when the device is included in a UE. The PMC 712 may increase the power conversion efficiency while providing desirable implementation size and heat dissipation characteristics.

While FIG. 7 shows the PMC 712 coupled only with the baseband circuitry 704. However, in other embodiments, the PMC 712 may be additionally or alternatively coupled with, and perform similar power management operations for, other components such as, but not limited to, application circuitry 702, RF circuitry 706, or FEM 708.

In some embodiments, the PMC 712 may control, or otherwise be part of, various power saving mechanisms of the device 700. For example, if the device 700 is in an RRC_Connected state, where it is still connected to the RAN node as it expects to receive traffic shortly, then it may enter a state known as Discontinuous Reception Mode (DRX) after a period of inactivity. During this state, the device 700 may power down for brief intervals of time and thus save power.

If there is no data traffic activity for an extended period of time, then the device 700 may transition off to an RRC_Idle state, where it disconnects from the network and does not perform operations such as channel quality feedback, handover, and so on. The device 700 goes into a very low power state and it performs paging where again it periodically wakes up to listen to the network and then powers down again. The device 700 may not receive data in this state, in order to receive data, it must transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 702 and processors of the baseband circuitry 704 may be used to execute elements of one or more instances of a protocol stack. For example, processors of the baseband circuitry 704, alone or in combination, may be used execute Layer 3, Layer 2, or Layer 1 functionality, while processors of the application circuitry 704 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

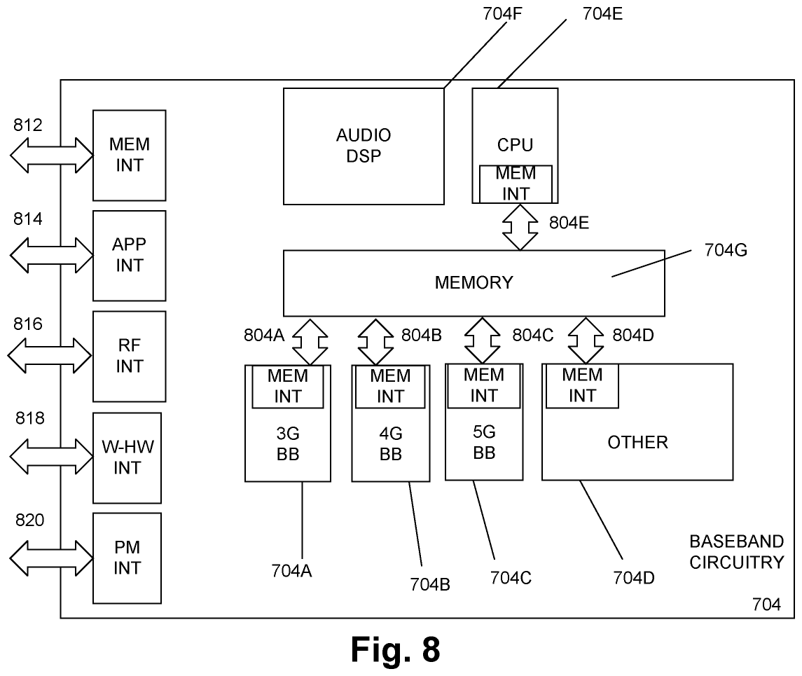

FIG. 8 illustrates example interfaces of baseband circuitry, in accordance with some embodiments of the disclosure. As discussed above, the baseband circuitry 704 of FIG. 7 may comprise processors 704A-704E and a memory 704G utilized by said processors. Each of the processors 704A-704E may include a memory interface, 804A-804E, respectively, to send/receive data to/from the memory 704G.

The baseband circuitry 704 may further include one or more interfaces to communicatively couple to other circuitries/devices, such as a memory interface 812 (e.g., an interface to send/receive data to/from memory external to the baseband circuitry 704), an application circuitry interface 814 (e.g., an interface to send/receive data to/from the application circuitry 702 of FIG. 7), an RF circuitry interface 816 (e.g., an interface to send/receive data to/from RF circuitry 706 of FIG. 7), a wireless hardware connectivity interface 818 (e.g., an interface to send/receive data to/from Near Field Communication (NFC) components, Bluetooth® components (e.g., Bluetooth® Low Energy), Wi-Fi® components, and other communication components), and a power management interface 820 (e.g., an interface to send/receive power or control signals to/from the PMC 712.

It is pointed out that elements of any of the Figures herein having the same reference numbers and/or names as elements of any other Figure herein may, in various embodiments, operate or function in a manner similar those elements of the other Figure (without being limited to operating or functioning in such a manner).

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional element.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. For example, other memory architectures e.g., Dynamic RAM (DRAM) may use the embodiments discussed. The embodiments of the disclosure are intended to embrace all such alternatives, modifications, and variations as to fall within the broad scope of the appended claims.

In addition, well known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

The following examples pertain to further embodiments. Specifics in the examples may be used anywhere in one or more embodiments. All optional features of the apparatus described herein may also be implemented with respect to a method or process.

Example 1 provides an apparatus of a User Equipment (UE) operable to communicate with an Evolved Node B (eNB) on a wireless network, comprising: one or more processors to: process one or more configuring transmissions from the eNB carrying one or more parameters for Common Search Space (CSS) for Wideband Coverage Enhancement (WCE) mode; establish a CSS encompassing one or more enhanced Physical Downlink Control Channel (ePDCCH) candidate transmissions based upon the one or more parameters for CSS for WCE mode; and monitor the one or more ePDCCH candidate transmissions for Downlink Control Information (DCI) in accordance with the one or more parameters for CSS for WCE mode, and an interface for receiving the one or more configuring transmissions and the one or more ePDCCH candidate transmissions from a receiving circuitry.

In example 2, the apparatus of example 1, wherein the one or more higher-layer signaling transmissions carry an indicator of a set of Physical Resource Blocks (PRBs) for CSS

In example 3, the apparatus of example 2, wherein the set of Physical Resource Blocks (PRBs) for CSS overlaps a set of PRBs for a UE Search Space (UESS).

In example 4, the apparatus of example 2, wherein the set of Physical Resource Blocks (PRBs) for CSS does not overlap a set of PRBs for a UE Search Space (UESS).

In example 5, the apparatus of any of examples 1 through 4, wherein one or more enhanced Control Channel Element (eCCE) indices are derived in accordance with the eCCE index derivation rule:

In example 6, the apparatus of any of examples 1 through 5, wherein a WCE mode indicator is provided by one of: a Physical Random Access Channel (PRACH) transmission, a higher-layer signaling transmission, or a DCI transmission, the WCE mode indicator having a first value indicating normal mode and a second value indicating WCE mode; and wherein the one or more ePDCCH candidate transmissions are monitored for DCI upon the WCE mode indicator having the second value.

In example 7, the apparatus of any of examples 1 through 6, wherein a subframe for the one or more ePDCCH candidate transmissions in the CSS depends upon at least one of: a System Information (SI) window; a paging occasion; and a Discovery Reference Signal Transmission Window (DTxW).

In example 8, the apparatus of any of examples 1 through 7, wherein the one or more configuring transmissions comprise one of: a Radio Resource Control transmission; a Master Information Block (MIB) transmission; or a System Information Block (SIB) transmission.

In example 9, the apparatus of example 8, wherein the one or more parameters for CSS for WCE mode include at least one of: a resource block assignment indicator; a number of Physical Resource Blocks (PRBs) indicator; and a Demodulation Reference Signal (DM RS) scrambling sequence indicator.

Example 10 provides a User Equipment (UE) device comprising an application processor, a memory, one or more antennas, a wireless interface for allowing the application processor to communicate with another device, and a touch-screen display, the UE device including the apparatus of any of examples 1 through 9.

Example 11 provides machine readable storage media having machine executable instructions that, when executed, cause one or more processors of a User Equipment (UE) operable to communicate with an Evolved Node-B (eNB) on a wireless network to perform an operation comprising: process one or more configuring transmissions from the eNB carrying one or more parameters for Common Search Space (CSS) for Wideband Coverage Enhancement (WCE) mode; establish a CSS encompassing one or more enhanced Physical Downlink Control Channel (ePDCCH) candidate transmissions based upon the one or more parameters for CSS for WCE mode; and monitor the one or more ePDCCH candidate transmissions for Downlink Control Information (DCI) in accordance with the one or more parameters for CSS for WCE mode.

In example 12, the machine readable storage media of example 11, wherein the one or more higher-layer signaling transmissions carry an indicator of a set of Physical Resource Blocks (PRBs) for CSS

In example 13, the machine readable storage media of example 12, wherein the set of Physical Resource Blocks (PRBs) for CSS overlaps a set of PRBs for a UE Search Space (UESS).

In example 14, the machine readable storage media of example 12, wherein the set of Physical Resource Blocks (PRBs) for CSS overlaps a set of PRBs for a UE Search Space (UESS).

In example 15, the machine readable storage media of any of examples 11 through 14, wherein one or more enhanced Control Channel Element (eCCE) indices are derived in accordance with the eCCE index derivation rule:

In example 16, the machine readable storage media of any of examples 11 through 15, wherein a WCE mode indicator is provided by one of: a Physical Random Access Channel (PRACH) transmission, a higher-layer signaling transmission, or a DCI transmission, the WCE mode indicator having a first value indicating normal mode and a second value indicating WCE mode; and wherein the one or more ePDCCH candidate transmissions are monitored for DCI upon the WCE mode indicator having the second value.

In example 17, the machine readable storage media of any of examples 11 through 16, wherein a subframe for the one or more ePDCCH candidate transmissions in the CSS depends upon at least one of: a System Information (SI) window; a paging occasion; and a Discovery Reference Signal Transmission Window (DTxW).

In example 18, the machine readable storage media of any of examples 11 through 17, wherein the one or more configuring transmissions comprise one of: a Radio Resource Control transmission; a Master Information Block (MIB) transmission; or a System Information Block (SIB) transmission.

In example 19, the machine readable storage media of example 18, wherein the one or more parameters for CSS for WCE mode include at least one of: a resource block assignment indicator; a number of Physical Resource Blocks (PRBs) indicator; and a Demodulation Reference Signal (DM RS) scrambling sequence indicator.

Example 20 provides an apparatus of a User Equipment (UE) operable to communicate with an Evolved Node B (eNB) on a wireless network, comprising: one or more processors to: process one or more configuring transmissions from the eNB carrying one or more parameters for Common Search Space (CSS) for Wideband Coverage Enhancement (WCE) mode; determine a CSS encompassing one or more enhanced Physical Downlink Control Channel (ePDCCH) candidate transmissions based upon the one or more parameters for CSS for WCE mode; and monitor the CSS for Downlink Control Information (DCI) based upon the one or more parameters for CSS for WCE mode, and an interface for receiving the one or more configuring transmissions and the one or more ePDCCH candidate transmissions from a receiving circuitry.

In example 21, the apparatus of example 20, wherein the one or more parameters for CSS for WCE mode comprise an indicator of a maximum number of 32 Resource Blocks (RBs) for CSS.

In example 22, the apparatus of any of examples 20 through 21, wherein the one or more parameters for CSS for WCE mode comprise an ePDCCH candidate transmission configuration indicator, specifying at least one of: two candidates for DCI format 1A corresponding to an Aggregation Level (AL) of 64; and two candidates for DCI format 1C corresponding to an AL of 32.

In example 23, the apparatus of any of examples 20 through 22, wherein a DCI of the one or more ePDCCH candidate transmissions is scrambled by a Radio Network Temporary Identifier (RNTI) selected from one of: a System Information RNTI (SI-RNTI); a Pilot Identity RNTI (PI-RNTI); a Random Access RNTI (RA-RNTI); or a Transmit Power Control Physical Uplink Control Channel RNTI (TPC-PUCCH-RNTI).

In example 24, the apparatus of any of examples 20 through 23, wherein the one or more configuring transmissions comprise a System Information Block 1 (SIB1) transmission; and wherein the one or more parameters for CSS for WCE mode include a scheduling information indicator.

In example 25, the apparatus of any of examples 20 through 24, wherein the one or more parameters for CSS for WCE mode comprise an ePDCCH candidate transmission configuration indicator for a CSS for System Information Block 1 (SIB1), specifying at least one of: one candidate for DCI format 1A corresponding to an Aggregation Level (AL) of 64, and one candidate for DCI format 1A corresponding to an AL of 32; and one candidate for DCI format 1C corresponding to an AL of 32, and one candidate for DCI format 1A corresponding to an AL of 16.

Example 26 provides a User Equipment (UE) device comprising an application processor, a memory, one or more antennas, a wireless interface for allowing the application processor to communicate with another device, and a touch-screen display, the UE device including the apparatus of any of examples 20 through 25.

Example 27 provides machine readable storage media having machine executable instructions that, when executed, cause one or more processors of a User Equipment (UE) operable to communicate with an Evolved Node-B (eNB) on a wireless network to perform an operation comprising: process one or more configuring transmissions from the eNB carrying one or more parameters for Common Search Space (CSS) for Wideband Coverage Enhancement (WCE) mode; determine a CSS encompassing one or more enhanced Physical Downlink Control Channel (ePDCCH) candidate transmissions based upon the one or more parameters for CSS for WCE mode; and monitor the CSS for Downlink Control Information (DCI) based upon the one or more parameters for CSS for WCE mode.

In example 28, the machine readable storage media of example 27, wherein the one or more parameters for CSS for WCE mode comprise an indicator of a maximum number of 32 Resource Blocks (RBs) for CSS.

In example 29, the machine readable storage media of any of examples 27 through 28, wherein the one or more parameters for CSS for WCE mode comprise an ePDCCH candidate transmission configuration indicator, specifying at least one of: two candidates for DCI format 1A corresponding to an Aggregation Level (AL) of 64; and two candidates for DCI format 1C corresponding to an AL of 32.

In example 30, the machine readable storage media of any of examples 27 through 29, wherein a DCI of the one or more ePDCCH candidate transmissions is scrambled by a Radio Network Temporary Identifier (RNTI) selected from one of: a System Information RNTI (SI-RNTI); a Paging Information RNTI (PI-RNTI); a Random Access RNTI (RA-RNTI); or a Transmit Power Control Physical Uplink Control Channel RNTI (TPC-PUCCH-RNTI).

In example 31, the machine readable storage media of any of examples 27 through 30, wherein the one or more configuring transmissions comprise a System Information Block 1 (SIB1) transmission; and wherein the one or more parameters for CSS for WCE mode include a scheduling information indicator.

In example 32, the machine readable storage media of any of examples 27 through 31, wherein the one or more parameters for CSS for WCE mode comprise an ePDCCH candidate transmission configuration indicator for a CSS for System Information Block 1 (SIB1), specifying at least one of: one candidate for DCI format 1A corresponding to an Aggregation Level (AL) of 64, and one candidate for DCI format 1A corresponding to an AL of 32; and one candidate for DCI format 1C corresponding to an AL of 32, and one candidate for DCI format 1A corresponding to an AL of 16.

In example 33, the apparatus of any of examples 1 through 9, and 20 through 25, wherein the one or more processors comprise a baseband processor.

In example 34, the apparatus of any of examples 1 through 9, and 20 through 25, comprising a memory for storing instructions, the memory being coupled to the one or more processors.

In example 35, the apparatus of any of examples 1 through 9, and 20 through 25, comprising a transceiver circuitry for at least one of: generating transmissions, encoding transmissions, processing transmissions, or decoding transmissions.

In example 36, the apparatus of any of examples 1 through 9, and 20 through 25, comprising a transceiver circuitry for generating transmissions and processing transmissions. An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

1-24. (canceled)

25. An apparatus of a User Equipment (UE) operable to communicate with an Evolved Node-B (eNB) on a wireless network, comprising:
one or more processors to:
process one or more configuring transmissions from the eNB carrying one or more parameters for Common Search Space (CSS) for Wideband Coverage Enhancement (WCE) mode;
establish a CSS encompassing one or more enhanced Physical Downlink Control Channel (ePDCCH) candidate transmissions based upon the one or more parameters for CSS for WCE mode; and
monitor the one or more ePDCCH candidate transmissions for Downlink Control Information (DCI) in accordance with the one or more parameters for CSS for WCE mode, and
an interface for receiving the one or more configuring transmissions and the one or more ePDCCH candidate transmissions from a receiving circuitry.

26. The apparatus of claim 25,
wherein the one or more higher-layer signaling transmissions carry an indicator of a set of Physical Resource Blocks (PRBs) for CSS

27. The apparatus of claim 25,
wherein a WCE mode indicator is provided by one of: a Physical Random Access Channel (PRACH) transmission, a higher-layer signaling transmission, or a DCI transmission, the WCE mode indicator having a first value indicating normal mode and a second value indicating WCE mode; and
wherein the one or more ePDCCH candidate transmissions are monitored for DCI upon the WCE mode indicator having the second value.

28. The apparatus of claim 25,
wherein a subframe for the one or more ePDCCH candidate transmissions in the CSS depends upon at least one of: a System Information (SI) window; a paging occasion; and a Discovery Reference Signal Transmission Window (DTxW).

29. The apparatus of claim 25,
wherein the one or more configuring transmissions comprise one of: a Radio Resource Control transmission; a Master Information Block (MIB) transmission; or a System Information Block (SIB) transmission.

30. The apparatus of claim 29,
wherein the one or more parameters for CSS for WCE mode include at least one of: a resource block assignment indicator; a number of Physical Resource Blocks (PRBs) indicator; and a Demodulation Reference Signal (DM-RS) scrambling sequence indicator.

31. Machine readable storage media having machine executable instructions that, when executed, cause one or more processors of a User Equipment (UE) operable to communicate with an Evolved Node-B (eNB) on a wireless network to perform an operation comprising:
process one or more configuring transmissions from the eNB carrying one or more parameters for Common Search Space (CSS) for Wideband Coverage Enhancement (WCE) mode;
establish a CSS encompassing one or more enhanced Physical Downlink Control Channel (ePDCCH) candidate transmissions based upon the one or more parameters for CSS for WCE mode; and
monitor the one or more ePDCCH candidate transmissions for Downlink Control Information (DCI) in accordance with the one or more parameters for CSS for WCE mode.

32. The machine readable storage media of claim 31,
wherein the one or more higher-layer signaling transmissions carry an indicator of a set of Physical Resource Blocks (PRBs) for CSS

33. The machine readable storage media of claim 31,
wherein a WCE mode indicator is provided by one of: a Physical Random Access Channel (PRACH) transmission, a higher-layer signaling transmission, or a DCI transmission, the WCE mode indicator having a first value indicating normal mode and a second value indicating WCE mode; and
wherein the one or more ePDCCH candidate transmissions are monitored for DCI upon the WCE mode indicator having the second value.

34. The machine readable storage media of claim 31,
wherein a subframe for the one or more ePDCCH candidate transmissions in the CSS depends upon at least one of: a System Information (SI) window; a paging occasion; and a Discovery Reference Signal Transmission Window (DTxW).

35. The machine readable storage media of claim 31,
wherein the one or more configuring transmissions comprise one of: a Radio Resource Control transmission; a Master Information Block (MIB) transmission; or a System Information Block (SIB) transmission.

36. The machine readable storage media of claim 35,
wherein the one or more parameters for CSS for WCE mode include at least one of: a resource block assignment indicator; a number of Physical Resource Blocks (PRBs) indicator; and a Demodulation Reference Signal (DM-RS) scrambling sequence indicator.

37. An apparatus of a User Equipment (UE) operable to communicate with an Evolved Node-B (eNB) on a wireless network, comprising:
one or more processors to:
process one or more configuring transmissions from the eNB carrying one or more parameters for Common Search Space (CSS) for Wideband Coverage Enhancement (WCE) mode;
determine a CSS encompassing one or more enhanced Physical Downlink Control Channel (ePDCCH) candidate transmissions based upon the one or more parameters for CSS for WCE mode; and
monitor the CSS for Downlink Control Information (DCI) based upon the one or more parameters for CSS for WCE mode, and
an interface for receiving the one or more configuring transmissions and the one or more ePDCCH candidate transmissions from a receiving circuitry.

38. The apparatus of claim 37,
wherein the one or more parameters for CSS for WCE mode comprise an indicator of a maximum number of 32 Resource Blocks (RBs) for CSS.

39. The apparatus of claim 37,
wherein the one or more parameters for CSS for WCE mode comprise an ePDCCH candidate transmission configuration indicator, specifying at least one of:
two candidates for DCI format 1A corresponding to an Aggregation Level (AL) of 64; and
two candidates for DCI format 1C corresponding to an AL of 32.

40. The apparatus of claim 37,
wherein a DCI of the one or more ePDCCH candidate transmissions is scrambled by a Radio Network Temporary Identifier (RNTI) selected from one of: a System Information RNTI (SI-RNTI); a Pilot Identity RNTI (PI-RNTI); a Random Access RNTI (RA-RNTI); or a Transmit Power Control Physical Uplink Control Channel RNTI (TPC-PUCCH-RNTI).

41. The apparatus of claim 37,
wherein the one or more configuring transmissions comprise a System Information Block 1 (SIB1) transmission; and
wherein the one or more parameters for CSS for WCE mode include a scheduling information indicator.

42. The apparatus of claim 37,
wherein the one or more parameters for CSS for WCE mode comprise an ePDCCH candidate transmission configuration indicator for a CSS for System Information Block 1 (SIB1), specifying at least one of:
one candidate for DCI format 1A corresponding to an Aggregation Level (AL) of 64, and one candidate for DCI format 1A corresponding to an AL of 32; and
one candidate for DCI format 1C corresponding to an AL of 32, and one candidate for DCI format 1A corresponding to an AL of 16.

43. Machine readable storage media having machine executable instructions that, when executed, cause one or more processors of a User Equipment (UE) operable to communicate with an Evolved Node-B (eNB) on a wireless network to perform an operation comprising:
process one or more configuring transmissions from the eNB carrying one or more parameters for Common Search Space (CSS) for Wideband Coverage Enhancement (WCE) mode;
determine a CSS encompassing one or more enhanced Physical Downlink Control Channel (ePDCCH) candidate transmissions based upon the one or more parameters for CSS for WCE mode; and
monitor the CSS for Downlink Control Information (DCI) based upon the one or more parameters for CSS for WCE mode.

44. The machine readable storage media of claim 43,
wherein the one or more parameters for CSS for WCE mode comprise an indicator of a maximum number of 32 Resource Blocks (RBs) for CSS.

45. The machine readable storage media of claim 43,
wherein the one or more parameters for CSS for WCE mode comprise an ePDCCH candidate transmission configuration indicator, specifying at least one of:
two candidates for DCI format 1A corresponding to an Aggregation Level (AL) of 64; and
two candidates for DCI format 1C corresponding to an AL of 32.

46. The machine readable storage media of claim 43,
wherein a DCI of the one or more ePDCCH candidate transmissions is scrambled by a Radio Network Temporary Identifier (RNTI) selected from one of: a System Information RNTI (SI-RNTI); a Paging Information RNTI (PI-RNTI); a Random Access RNTI (RA-RNTI); or a Transmit Power Control Physical Uplink Control Channel RNTI (TPC-PUCCH-RNTI).

47. The machine readable storage media of claim 43,
wherein the one or more configuring transmissions comprise a System Information Block 1 (SIB1) transmission; and
wherein the one or more parameters for CSS for WCE mode include a scheduling information indicator.

48. The machine readable storage media of claim 43,
wherein the one or more parameters for CSS for WCE mode comprise an ePDCCH candidate transmission configuration indicator for a CSS for System Information Block 1 (SIB1), specifying at least one of:
one candidate for DCI format 1A corresponding to an Aggregation Level (AL) of 64, and one candidate for DCI format 1A corresponding to an AL of 32; and
one candidate for DCI format 1C corresponding to an AL of 32, and one candidate for DCI format 1A corresponding to an AL of 16.
